(19) United States
(12) Patent Application Publication
(10) Pub. No.: US 2024/0117105 A1
(43) Pub. Date: Apr. 11, 2024

(54) POLYESTER COMPOSITIONS COMPRISING TETRAMETHYL CYCLOBUTANEDIOL AND 1,4-CYCLOHEXANEDIMETHANOL HAVING AN IMPROVED CATALYST SYSTEM COMPRISING LITHIUM AND GALLIUM

(71) Applicant: Eastman Chemical Company, Kingsport, TN (US)

(72) Inventors: Brian Alan Schaefer, Kingsport, TN (US); Kate Elizabeth Allen, Jonesborough, TN (US)

(73) Assignee: Eastman Chemical Company, Kingsport, TN (US)

(21) Appl. No.: 18/257,669

(22) PCT Filed: Dec. 16, 2021
(86) PCT No.: PCT/US2021/063663

§ 371 Date: Jun. 15, 2023

Related U.S. Application Data
(60) Provisional application No. 63/199,303, filed on Dec. 18, 2020.
(60) Provisional application No. 63/199,304, filed on Dec. 18, 2020.
(60) Provisional application No. 63/199,305, filed on Dec. 18, 2020.
(60) Provisional application No. 63/199,306, filed on Dec. 18, 2020.
(60) Provisional application No. 63/199,308, filed on Dec. 18, 2020.
(60) Provisional application No. 63/199,309, filed on Dec. 18, 2020.
(60) Provisional application No. 63/199,310, filed on Dec. 18, 2020.

(51) Int. Cl. C08G 63/183; C08G 63/83; C08L 67/02

(52) U.S. Cl. CPC C08G 63/183; C08G 63/83; C08L 67/02

(57) ABSTRACT

This invention relates to a polyester composition comprising: (1) at least one polyester which comprises: (a) a dicarboxylic acid component comprising: (i) about 70 to about 100 mole % residues of terephthalic acid or esters thereof; (ii) about 0 to about 30 mole % of aromatic and/or aliphatic dicarboxylic acid residues having up to 20 carbon atoms; (b) a glycol component comprising: (i) about 10 to about 50 mole % of 2,2,4,4-tetramethyl-1,3-cyclobutanediol residues; (ii) about 50 to about 90 mole % residues of 1,4-cyclohexanedimethanol; wherein the total mole % of the dicarboxylic acid component is 100 mole %, wherein the total mole % of the diol component is 100 mole %; and (2) lithium atoms, gallium atoms, and less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of tin atoms.

### FIELD OF THE INVENTION

The present invention relates to polyesters made from residues of terephthalic acid or ester(s) thereof, 2,2,4,4-tetramethyl-1,3-cyclobutanediol (TMCD), and 1,4-cyclohexanedimethanol (CHDM), and polyester compositions comprising at least one of these polyesters. The polyesters can be catalyzed by a catalyst system that contains lithium and gallium, and can result in good TMCD incorporation, improved color, and reactivity to achieve desired inherent viscosity over a broad compositional range.

### BACKGROUND OF THE INVENTION

Tin (Sn) based catalysts are typically the most efficient at incorporating TMCD into a polyester (Caldwell et al. CA 740050, and Kelsey et al., Macromolecules 2000, 33, 581). However, tin based catalysts typically produce a yellow to amber colored copolyester in the presence of EG, e.g., see Kelsey, U.S. Pat. No. 5,705,575; and Morris et al., U.S. Pat. No. 5,955,565.

Titanium (Ti) based catalysts are reported to be ineffective at incorporating 2,2,4,4-tetramethyl-1,3-cyclobutanediol (TMCD) into a polyester (Caldwell et al. CA 740050, Kelsey et al., Macromolecules 2000, 33, 5810).

US Patent Application No. 2007/0142511 discloses that polyesters with a glycol component comprising TMCD and EG, and optionally, certain levels of CHDM, can be prepared with titanium based catalysts. It indicates that TMCD incorporation can be improved by use of tin based catalysts in addition to titanium based catalysts. It further indicates that the color of these copolyesters can be improved with the addition of certain levels of phosphorus containing compounds. This publication discloses a wide compositional range with a glycol component comprising: (i) about 1 to about 90 mole % TMCD residues; and (ii) about 99 to about 10 mole % EG residues. However, whenever relatively high levels of EG were present, e.g., polymers with only TMCD and EG, the catalyst system required a significant amount of Sn.

There is a commercial need for a polymeric material with a combination of properties making it ideal for injection molding, blow molding, extrusion, and thermoformed film and sheet applications including a combination of one or more, two or more, or three or more, of good notched Izod impact strength, good inherent viscosities, good glass transition temperature (Tg), good flexural modulus, good tensile strength, good clarity, good color, good dishwasher durability, good TMCD incorporation and good/improved melt and/or thermal stability.

### SUMMARY OF THE INVENTION

It has been found that significant amounts of TMCD can be incorporated into a polymer when DMT, TMCD, and CHDM are catalyzed with at least one lithium catalyst and at least one gallium catalyst. It has also been found that a catalyst system containing a combination of lithium and gallium catalysts can provide a combination of one or more, two or more, or three or more, of good notched Izod impact strength, good inherent viscosities, good glass transition temperature (Tg), good flexural modulus, good tensile strength, good clarity, good color, good dishwasherability, good TMCD incorporation and good/improved melt and/or thermal stability.

In certain aspects, a catalyst combination of lithium and gallium can result in a copolyester with good TMCD incorporation, and/or reactivity to achieve the desired inherent viscosity over a broad compositional range that includes but is not limited to: (a) a dicarboxylic acid component comprising: (i) 70 to 100 mole % terephthalic acid and/or dimethyl terephthalate residues; and (ii) about 0 to about 30 mole % of aromatic and/or aliphatic dicarboxylic acid residues having up to 20 carbon atoms; and (b) a glycol component comprising about 10 to about 50 mole % 2,2,4,4-tetramethyl-1,3-cyclobutanediol (TMCD) residues and about 50 to about 90 mole % 1,4-cyclohexanedimethanol (CHDM) residues; wherein the total mole % of the dicarboxylic acid component of the final polyester is 100 mole %; and wherein the total mole % of the diol component of the final polyester is 100 mole %.

It is unpredictable that the polyesters and/or polyester compositions of the invention would have these properties when using a catalyst system to prepare them that does not require the use of a tin catalyst and/or a titanium catalyst.

In one aspect, the polyesters and/or polyester compositions of the invention can comprise residues of 2,2,4,4-tetramethyl-1,3-cyclobutanediol in the amount of from about 10 to about 45 mole %, or from about 10 to about mole %, or from about 10 to about 30 mole %, or from about 15 to about 45 mole %, or from about 15 to about 40 mole %, or from about 20 to about 50 mole %, or from about 20 to about 45 mole %, or from about 20 to about 40 mole %, or from about 20 to about 30 mole %, or from about 25 to about 50 mole %, or from about 25 to about 45 mole %, or from about 25 to about 40 mole %, or from about 30 to about 50 mole %, or from about 30 to about 45 mole %, or from about 30 to about 40 mole %.

In one aspect, the polyesters and/or polyester compositions of the invention can comprise CHDM residues in the amount of from about 55 to about 90 mole %, of from about 60 to about 90 mole %, of from about 70 to about 90 mole %, or from about 55 to about 85 mole %, or from about 60 to about 85 mole %, or from about 50 to about 80 mole %, or from about 55 to about 80 mole %, or from about 60 to about 80 mole, or from about 70 to about 80 mole %, or from about 50 to about 75 mole %, or from about 55 to about 75 mole %, or from about 60 to about 75 mole %, or from about 60 to about 70 mole %, or from about 50 to about 70 mole %, or from about 60 to about 70 mole %.

In one aspect, the polyesters and/or polyester compositions of the invention can comprise residues of TMCD in the amount of 20 to 45 mole % and residues of CHDM in the amount of 55 to 80 mole %, or residues of TMCD in the amount of 20 to 40 mole % and residues of CHDM in the amount of 60 to 80 mole %, or residues of TMCD in the amount of 20 to 35 mole % and residues of CHDM in the amount of 65 to 80 mole %, or 25 to 45 mole % and residues of CHDM in the amount of 55 to 75 mole %, or residues of TMCD in the amount of 25 to 40 mole % and residues of CHDM in the amount of 60 to 75 mole %, or residues of TMCD in the amount of 25 to 35 mole % and residues of CHDM in the amount of 65 to 75 mole %, or residues of TMCD in the amount of 30 to 35 mole % and residues of CHDM in the amount of 65 to 70 mole %.

In one aspect, the polyesters and/or polyester compositions of the invention can have a molar ratio of TMCD:CHDM from 1:9 to 1:1, or from 1:4 to 1:1, or from or from 1:3 to 1:1.5, or from 1:3 to 1:1, or from 1:2 to 1:1, or from 1:1.5 to 1:1.

In one aspect, the polyesters and/or polyester compositions of the invention can comprise TMCD residues which are a combination comprising greater than 50 mole % of cis-TMCD and less than 50 mole % of trans-TMCD, or greater than 70 mole % of cis-TMCD and less than 30 mole % of trans-TMCD, or greater than 75 mole % of cis-TMCD and less than 25 mole % of trans-TMCD, or greater than 80 mole % of cis-TMCD and less than 20 mole % of trans-TMCD, or greater than 90 mole % of cis-TMCD and less than 10 mole % of trans-TMCD, or greater than 95 mole % of cis-TMCD and less than mole % of trans-TMCD.

In one aspect, modifying glycols can comprise the remaining mole percentages of the glycol component.

In one aspect, for the glycol component of the polyesters and/or polyester compositions of the invention, the modifying glycols can comprise diethylene glycol, 1,2-propanediol, 1,3-propanediol, 2-methyl-1,3-propanediol, ethylene glycol, 1,4-butanediol, 1,5-pentanediol, 1,6-hexanediol, p-xylene glycol, neopentyl glycol, isosorbide, polytetramethylene glycol, or combinations thereof.

In one aspect, the polyesters and/or polyester compositions of the invention can comprise less than 25 mole %, or less than 20 mole %, or less than 15 mole %, or less than 10 mole %, or less than 5 mole %, or less than 1 mole %, or 0 mole % of the residues of at least one modifying glycol, e.g., ethylene glycol.

In one aspect, the polyesters and/or polyester compositions of the invention can comprise residues or no residues of at least one of 1,3-propanediol, 1,4-butanediol, and/or neopentyl glycol.

In one aspect, the polyesters and/or polyester compositions of the invention can comprise no hexanediol, and/or no propanediol, and/or no butanediol

In one aspect, the diacid component of the polyesters and/or polyester compositions of the invention can comprise modifying aromatic and/or aliphatic dicarboxylic acid ester residues.

In one aspect, the diacid component of the polyesters and/or

polyester compositions of the invention can comprise residues of dimethyl terephthalate or terephthalic acid.

In one aspect, the polyester compositions of the invention can comprise:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic and/or aliphatic dicarboxylic acid residues having up to 20 carbon atoms;
   (b) a glycol component comprising:
      (i) about 15 to about 50 mole %, or from about 25 to about 45 mole %, or from about 30 to about 40 mole % of TMCD residues;
      (ii) about 50 to about 85, or from 55 mole % to about 75 mole %, or from about 60 to 70 mole %, residues of CHDM;
wherein the total mole % of the dicarboxylic acid component is 100 mole %,
wherein the total mole % of the diol component is 100 mole %; and
(2) lithium atoms, gallium atoms, and less than 30 ppm, or less than ppm, or less than 10 ppm, or less than 5 ppm, or less than 2 ppm, or from 0 to 30 ppm, or from 0 to 20 ppm, or from 0 to 10 ppm, or 0 ppm of any of tin atoms, and/or titanium atoms;
wherein the inherent viscosity is from 0.35 to 1.2 dL/g, or from 0.35 to 1.0 dL/g, or from 0.35 to 0.80 dL/g, or from 0.35 to 0.75 dL/g, or from 0.40 to 0.75, or from 0.45 to 0.75 dL/g, as determined in 60/40 (wt/wt) phenol/tetrachloroethane at a concentration of 0.5 g/100 ml at 25° C.; and having a b* value of less than 20, or less than 15, or less than 14, or less than 13, or less than 12, or less than 11, or less than 10, or less than 9, or less than 8.5, or less than 8, or less than 7, or less than 6, or less than 5, or less than 4, or less than 3, or from 1 to 10, or from 1 to 9, or from 1 to 8, or from 1 to 7, or from 1 to 6, or from 1 to 5, or from 2 to 20, or from 2 to 18, or from 2 to 15, or from 2 to 14, or from 2 to less than 10, or from 3 to 20, or from 3 to less than 20; or from 3 to 18, or from 3 to 15, or from 3 to 14, or 3 to 12, or 3 to 10, or 3 to less than 10, or 3 to 7, or 3 to 5, and an L* value of from 70 to 95 or from 75 to 90, as determined by the L*a*b* color system of the CIE (International Commission on Illumination). In some embodiments, the a* value can also be less than 2, or less than 1, or less than 0.50, or less than 0, or less than −0.01, or less than −0.50, or less than −1, or less than −1.5, or less than −2.

In one aspect, for all of the polyester compositions of the invention, the inherent viscosity can be from 0.35 to 1.2 dL/g, or from 0.35 to 0.80 dL/g, or from 0.35 to 0.75 dL/g, or 0.35 to 0.70 dL/g, or 0.35 to 0.60 dL/g, or 0.40 to 0.75 dL/g, or 0.40 to 0.70 dL/g, or 0.40 to 0.65 dL/g, or 0.40 to 0.60 dL/g, or 0.45 to 0.75 dL/g, or 0.45 to 0.70 dL/g, or 0.45 to 0.65 dL/g, or 0.45 to 0.60 dL/g, or from 0.50 to 1.2 dL/g, or from 0.50 to 0.80 dL/g, or from 0.50 to 0.75 dL/g, or 0.50 to 0.70 dL/g, or 0.50 to 0.65 dL/g, or 0.50 to 0.60 dL/g, or from 0.55 to 0.75 dL/g, or from 0.55 to 0.70 dL/g, or from 0.60 to 0.75 dL/g, as determined in 60/40 (wt/wt) phenol/tetrachloroethane at a concentration of 0.5 g/100 mi at 25° C.

In one aspect, the polyester compositions of the invention can have a Tg of from 85 to 130° C., or from 100 to 130° C., or from 100 to 125° C., or from 100 to 120° C.

In one aspect, the polyesters and/or polyester compositions of the invention can have a number average molecular weight of from 4,800 to 16,000.

In one aspect, the polyesters and/or polyester compositions of the invention can have a b* value of from −10 to less than 15, −10 to less than 10, or from −3 to 10, or from −5 to 5, or from −5 to 4, or from −5 to 3, or from 1 to 20, or from 1 to 18, or from 1 to 15, or from 1 to 14, or from 1 to 12, or 1 to less than 10, or from 1 to 10, or from 1 to 9, or from 1 to 8, or from 1 to 7, or from 1 to 6, or from 1 to 5, or from 2 to 15, or from 2 to 14, or from 2 to less than 10, or from 3 to 15, or from 3 to 14, or 3 to less than 10, or from 3 to less than 9, or less than 20, or less than 15, or less than 14, or less than 13, or less than 12, or less than 11, or less than 10, or less than 9, or less than 8.5, or less than 8, or less than 7, or less than 6, or less than 6.5, or less than 5, or less than 4, or less than 3, as determined by the L*a*b* color system of the CIE (International Commission on Illumination).

In one aspect, the polyesters and/or polyester compositions of the invention can have an L* value of from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 99, or from 70 to 95, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In one embodiment, the b* and/or L* and/or a*values can be obtained in the presence of and/or in the absence of toner(s).

In one aspect, the polyesters and/or polyester compositions of the invention can comprise residues of at least one branching agent an amount of 0.01 to 10 mole %, or 0.01 to 5 mole %, based on the total mole percentage of the diacid or diol residues.

In one aspect, the polyesters and/or polyester compositions of the invention can have a melt viscosity less than 30,000, or less than 20,000, or less than 12,000, or less than 10,000, or less than 7,000, or less than 5,000 poise, or less than 3,000 poise, as measured at 1 radian/second on a rotary melt rheometer at 290° C.

In one aspect, the polyesters and/or polyester compositions of the invention can have a notched Izod impact strength of at least 1 ft-lbs/inch, or at least 2 ft-lbs/inch, or at least 3 ft-lbs/inch, or 7.5 ft-lbs/in, or 10 ft-lbs/in at 23° C. according to ASTM D256 with a 10-mil notch in a ⅛-inch thick bar.

In one aspect, the polyester compositions of the invention comprise at least one lithium source comprising at least one of lithium carbonate, lithium acetate, lithium benzoate, lithium succinate, lithium acetylacetonate, lithium methoxide, lithium oxalate, lithium nitrate, lithium ethoxide, lithium hydroxide, lithium hydride, lithium glycoxide, alkyl lithium, lithium gallium hydride, lithium borohydride, lithium oxide.

In one aspect, the polyester compositions of the invention comprise at least one lithium source comprising at least one of lithium acetate, lithium acetylacetonate, lithium hydroxide, lithium carbonate, lithium oxalate, or lithium nitrate.

In one aspect, the polyester compositions of the invention comprise at least one lithium source which is lithium acetylacetonate.

In one aspect, the polyester compositions of the invention can comprise lithium atoms in the amount of from 20 to 1000 ppm, or from 20 to 750 ppm, or from 20 to 500 ppm, or from 20 to 300 ppm, or from 20 to 275 ppm, or from 20 to 250 ppm, or from 20 to 200 ppm, or from 20 to 175 ppm, or from 20 to 150 ppm, or from 20 to 125 ppm, or from 20 to 120 ppm, or from 20 to 115 ppm, or from 20 to 110 ppm, or from 20 to 100 ppm, or from 25 to 1000 ppm, or from 25 to 750 ppm, or from 25 to 500 ppm, or from 25 to 300 ppm, or from 25 to 275 ppm, or from 25 to 250 ppm, or from 25 to 200 ppm, or from 25 to 175 ppm, or from 25 to 150 ppm, or from 25 to 125 ppm, or from 25 to 120 ppm, or from 25 to 115 ppm, or from 25 to 110 ppm, or from 25 to 100 ppm, or from 30 to 1000 ppm, or from 30 to 750 ppm, or from 30 to 500 ppm, or from to 300 ppm, or from 30 to 275 ppm, or from 30 to 250 ppm, or from 30 to 200 ppm, or from 30 to 175 ppm, or from 30 to 150 ppm, or from 30 to 125 ppm, or from 30 to 120 ppm, or from 30 to 115 ppm, or from 30 to 110 ppm, or from 30 to 100 ppm, or from 40 to 1000 ppm, or from 40 to 750 ppm, or from to 500 ppm, or from 40 to 300 ppm, or from 40 to 275 ppm, or from 40 to 250 ppm, or from 40 to 200 ppm, or from 40 to 175 ppm, or from 40 to 150 ppm, or from 40 to 125 ppm, or from 40 to 120 ppm, or from 40 to 115 ppm, or from 40 to 110 ppm, or from 30 to 100 ppm, or from 50 to 1000 ppm, or from 50 to 750 ppm, or from 50 to 500 ppm, or from 50 to 300 ppm, or from 50 to 275 ppm, or from 50 to 250 ppm, or from 50 to 200 ppm, or from 50 to 175 ppm, or from 50 to 150 ppm, or from 50 to 140 ppm, or from 50 to 130 ppm, or from 50 to 125 ppm, or from 50 to 120 ppm, or from 50 to 115 ppm, or from 50 to 110 ppm, or from 50 to 100 ppm, or from 60 to 1000 ppm, or from 60 to 750 ppm, or from 60 to 500 ppm, or from 60 to 300 ppm, or from 60 to 275 ppm, or from 60 to 250 ppm, or from 60 to 200 ppm, or from 60 to 175 ppm, or from 60 to 150 ppm, or from 60 to 140 ppm, or from 60 to 130 ppm, or from 60 to 125 ppm, or from 60 to 120 ppm, or from 60 to 115 ppm, or from 60 to 110 ppm, or from 60 to 100 ppm, or from 75 to 1000 ppm, or from 75 to 750 ppm, or from 75 to 500 ppm, or from 75 to 300 ppm, or from 75 to 250 ppm, or from 75 to 200 ppm, or from 75 to 175 ppm, or from 75 to 150 ppm, or from 75 to 140 ppm, or from 75 to 130 ppm, or from 75 to 125 ppm, or from 75 to 120 ppm, or from 75 to 115 ppm, or from 75 to 110 ppm, or from 75 to 100 ppm, or from 80 to 1000 ppm, or from 80 to 750 ppm, or from 80 to 500 ppm, or from 80 to 300 ppm, or from 80 to 275 ppm, or from 80 to 250 ppm, or from 80 to 200 ppm, or from 80 to 175 ppm, or from 80 to 150 ppm, or from 80 to 140 ppm, or from 80 to 130 ppm, or from 80 to 125 ppm, or from 80 to 120 ppm, or from 80 to 115 ppm, or from 90 to 1000 ppm, or from 90 to 750 ppm, or from 90 to 500 ppm, or from 90 to 300 ppm, or from 90 to 275 ppm, or from 90 to 250 ppm, or from 90 to 200 ppm, or from 90 to 175 ppm, or from 90 to 150 ppm, or from 90 to 140 ppm, or from 90 to 130 ppm, or from 90 to 125 ppm, or from 90 to 120 ppm, or from 90 to 115 ppm, or from 100 to 1000 ppm, or from 100 to 750 ppm, or from 100 to 500 ppm, or from 100 to 400 ppm, or from 100 to 300 ppm, or from 100 to 275 ppm, or from 100 to 250 ppm, relative to the mass of final polyester.

In one aspect, the amount of lithium atoms present in the polyesters and/or polyester compositions of the invention can generally range from at least 5 ppm, or at least 8 ppm, or at least 10 ppm, or at least 15 ppm, or at least 20 ppm, or at least 25 ppm, or at least 30 ppm, or at least 35 ppm, or at least 40 ppm, or at least 45 ppm, or at least 50 ppm, or at least 75 ppm, or at least 80 ppm, or at least 90 ppm, or less than 150 or less than 125 ppm, and less than 115 ppm, relative to the mass of the final polyester.

In one aspect, the range of lithium atoms by weight can be from 50 ppm to 300 ppm, or from 50 ppm to 250 ppm, or from 50 to 200 ppm, or from 50 ppm to 150 ppm, or from 50 ppm to 125 ppm, or from 50 ppm to 115 ppm, or from 60 ppm to 300 ppm, or from 60 ppm to 250 ppm, or from 60 to 200 ppm, or from 60 ppm to 150 ppm, or from 60 ppm to 125 ppm, or from 60 ppm to 115 ppm, or from 75 ppm to 300 ppm, or from 75 ppm to 250 ppm, or from 75 to 200 ppm, or from 75 ppm to 150 ppm, or from 75 ppm to 125 ppm, or from 75 ppm to 115 ppm, relative to the mass of the final polyester.

In one aspect, the polyester compositions can comprise at least one gallium source which is catalytically active. These gallium compounds can include gallium compounds with at least one organic substituent.

Suitable examples of gallium compounds can comprise at least one the carboxylic acid salts of gallium. Examples of gallium can comprise at least one gallium source is selected from gallium acetate, gallium benzoate, gallium sulfate, gallium lactate, gallium laurate, gallium stearate, gallium alcoholates, gallium ethylate, gallium isopropoxide, gallium tri-n-butyrate, gallium tri-tert-butyrate, mono-sec-butoxygallium diisopropylate, and gallium chelates, ethyl acetoacetate gallium diisopropylate, gallium tris(ethyl acetoacetate), gallium alkyl acetoacetate, gallium diisopropylate, gallium monoacetylacetate bis(ethyl acetoacetate), gallium tris(acetyl acetate), or gallium acetylacetonate.

In one aspect, the polyester compositions of the invention can contain gallium hydroxide, gallium acetylacetonate, gallium acetate, gallium isopropoxide or gallium sulfate.

In one aspect, the polyester compositions of the invention can comprise at least one gallium source selected from gallium acetylacetonate and gallium isopropoxide.

In one aspect, the polyester compositions of the invention at least one gallium source can be gallium acetylacetonate.

In one aspect, the polyester compositions of the invention can comprise gallium atoms in the amount of from 50 to 1000 ppm, or from 50 to 750 ppm, or from 50 to 500 ppm, or from 50 to 300 ppm, or from 50 to 250 ppm, or from 50 to 200 ppm, or from 60 to 1000 ppm, or from 60 to 750 ppm, or from 60 to 500 ppm, or from 60 to 300 ppm, or from 60 to 250 ppm, or from 60 to 200 ppm, or from 75 to 1000 ppm, or from 75 to 750 ppm, or from 75 to 500 ppm, or from 75 to 300 ppm, or from 75 to 250 ppm, or from 75 to 200 ppm, or from 100 to 1000 ppm, or from 100 to 750 ppm, or from 100 to 500 ppm, or from 100 to 400 ppm, or from 100 to 300 ppm, or from 100 to 250 ppm, or from 100 to 200, or from 150 to 1000 ppm, or from 150 to 750 ppm, or from 150 to 500 ppm, or from 150 to 400 ppm, or from 150 to 300 ppm, or from 150 to 250 ppm, or from 200 to 1000 ppm, or from 200 to 750 ppm, or from 200 to 500 ppm, or from 200 to 400 ppm, or from 200 to 300 ppm, or from 200 to 250 ppm, or from 250 to 1000 ppm, or from 250 to 750 ppm, or from 250 to 500 ppm, or from 250 to 475 ppm, or from 250 to 450 ppm, or from 250 to 400 ppm, or 250 to 375 ppm, or from 250 to 350 ppm, or from 200 to 300 ppm, or from 200 to 250 ppm, or from 275 to 1000 ppm, or from 275 to 750 ppm, or from 275 to 500 ppm, or from 275 to 475 ppm, or from 275 to 450 ppm, or from 275 to 425 ppm, or from 275 to 400 ppm, or from 275 to 350 ppm, or from 300 to 1000 ppm, or from 300 to 750 ppm, or from 300 to 500 ppm, or from 300 to 475 ppm, or from 300 to 450 ppm, or from 300 to 425 ppm, or from 300 to 400 ppm, or from 325 to 1000 ppm, or from 325 to 750 ppm, or from 325 to 500 ppm, or from 325 to 475 ppm, or from 325 to 450 ppm, or from 325 to 425 ppm, relative to the mass of final polyester being prepared.

In one aspect, the polyesters and/or polyester compositions of the invention can have at least one ratio of lithium atoms to gallium atoms in ppm, relative to the mass of final polyester being prepared from as follows: 0.50-1:5 to 5:1, or from 0.50-1:4 to 4:1, or from 0.50-1:3 to 3:1, or from 0.50:1 to 1:5, or from 0.50-1 to 1:4, or from 0.60-1:5 to 5:1, or from 0.60-1:4 to 4:1, or from 0.60-1:3 to 3:1, or from 0.60:1 to 1:5, or from 0.60-1 to 1:4, or from 0.70-1:5 to 5:1, or from 0.70-1:4 to 4:1, or from 0.70-1:3 to 3:1, or from 0.70-1:2 to 2:1, or from 0.70-1.2 to 1:4, or from 0.75-1:5 to 5:1, or from 0.75-1.2 to 1:4 to 4:1, or from 0.75-1:3 to 3:1, or from 0.75-1:2 to 2:1, or from 0.75-1.0 to 1:4, or from 0.80:1.2 to 1:4, or from 0.80-1:5 to 5:1, or from 0.80-1:5 to 5:1, or from 0.80-1.2 to 1:4 to 4:1, or from 0.80-1:3 to 3:1, or from 0.80-1:2 to 2:1, or from 0.80-1.2 to 1:4.

In certain aspects, the polyesters and/or polyester compositions of the invention can have a total of catalyst metal atoms present in the composition in the range of from 200 to 2000, or from 200 to 1000 ppm, or from 200 to 800 ppm, or from 200 to 750 ppm, or from 200 to 700 ppm, 200 to 600 ppm, or from 200 to 500 ppm, or from 200 to 400 ppm, or from 200 to 300 ppm, or 250 to 600 ppm, or from 250 to 500 ppm, or from 250 to 450 ppm, or from 250 to 400 ppm, or from 300 to 600 ppm, or from 300 to 450 ppm, or from 350 to 450 ppm, or from 300 to 400 ppm, or from 350 to 450 ppm, or from 300 to 500 ppm, or from 300 to 450 ppm, relative to the mass of final polyester being prepared.

In one aspect, the polyester useful in the invention can include polyesters having a degree of polymerization of from 0.01 to 300, or 0.01 to 250, or 0.01 to 200, or 0.01 to 150, or 0.01 to 130, or 0.01 to 120, or 0.10 to 300, or 0.10 to 250, or 0.10 to 200, or 0.10 to 150, or 0.10 to 130, or 0.10 to 120, or 0.20 to 300, or 0.20 to 250, or 0.20 to 200, or 0.20 to 150, or 0.20 to 130, or 0.20 to 120, or 0.15 to 300, or 0.15 to 250, or 0.15 to 200, or 0.15 to 150, or 0.15 to 130, or 0.15 to 120.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of titanium atoms and/or tin atoms.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of manganese atoms.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of zinc atoms.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of titanium atoms, tin atoms, and/or manganese atoms.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of titanium atoms, tin atoms, and/or zinc atoms.

In one embodiment, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of aluminum atoms.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of titanium atoms, tin atoms, manganese atoms, magnesium atoms, cobalt atoms, calcium atoms, cadmium atoms, and/or zinc atoms and can exclude any combination of these or can exclude all of these.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of manganese atoms, zinc atoms, calcium atoms, and/or cadmium atoms.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of the Group II metals of the Periodic Table.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of germanium atoms and/or antimony atoms.

In one aspect, at least one polyester useful in the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of sodium atoms and/or potassium atoms.

In one aspect, the polyester compositions of the invention can comprise blends of at least one polyester useful in the invention and at least one polymer chosen from at least one of the following: other polyesters (such as polyethylene terephthalate (PET), including recycled PET, poly(cyclohexylene) terephthalate (e.g., PCT), modified PET or PET modified with 1,4-cycllohexanedimethanol CHDM (e.g., PETG), poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

In one aspect, the polyester compositions of the invention can comprise blends of the polyester(s) useful in the invention with recycled poly(ethylene terephthalate)(rPET).

In one aspect, the polyester compositions of the invention can comprise at least one polycarbonate, or no polycarbonate, or no carbonate groups.

In one aspect, the polyester compositions of the invention can contain crosslinking agent or no crosslinking agent.

In one aspect, the polyester compositions of the invention can comprise residues of at least one phosphorus compound.

In one aspect, the polyester compositions of the invention can comprise residues of phosphoric acid, phosphorous acid, phosphonic acid, phosphinic acid, phosphonous acid, and/or various esters and/or salts thereof. These esters can be alkyl, branched alkyl, substituted alkyl, difunctional alkyl, alkyl ethers, aryl, and substituted aryl.

In one aspect, the polyester compositions of the invention can comprise at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed aryl alkyl phosphites, reaction products thereof, and/or combinations thereof.

In one aspect, the polyester compositions of the invention can comprise at least one of substituted or unsubstituted alkyl phosphate esters, substituted or unsubstituted aryl phosphate esters, mixed substituted or unsubstituted alkyl aryl phosphate esters, reaction products thereof, and combinations thereof.

In one aspect, the polyesters and/or polyester compositions of the invention can comprise no phosphorus compound.

In one aspect, there is provided a process for making any of the polyester compositions herein comprising the following steps:
(I) heating a mixture at least one temperature chosen from 150° C. to 300° C., under at least one pressure chosen from the range of 0 psig to 75 psig wherein said mixture comprises:
   (a) a dicarboxylic acid component comprising:
      (i) 70 to 100 mole % of terephthalic acid residues;
      (ii) 0 to 30 mole % of aromatic dicarboxylic acid residues having up to 20 carbon atoms; and
      (iii) 0 to 10 mole % of aliphatic dicarboxylic acid residues having up to 16 carbon atoms; and
   (b) a glycol component comprising:
      (i) 10 to 50 mole % of TMCD residues; and
      (ii) 50 to 90 mole % of CHDM residues;
wherein the molar ratio of glycol component/dicarboxylic acid component added in Step (I) is 1.0-1.5/1.0;
(II) heating the product of Step (I) at a temperature of 230° C. to 320° C. for 1 to 6 hours under at least one pressure chosen from the range of the final pressure of Step (I) to 0.02 torr absolute;
wherein the mixture in Steps (I) or (II), respectively, when heated, is heated in the presence of at least one catalyst selected from at least one gallium compound and one lithium compound;
wherein the final product after Step (II) comprises lithium atoms and gallium atoms;
wherein the total mole % of the dicarboxylic acid component of the final polyester is 100 mole %;
wherein the total mole % of the glycol component of the final polyester is 100 mole %;
wherein the inherent viscosity of the final polyester is from 0.35 to 1.2 dL/g as determined in 60/40 (wt/wt) phenol/tetrachloroethane at a concentration of 0.25 g/50 ml at 25° C.; and
wherein the final polyester has a Tg from 85° C. to 130° C.

In one aspect, the process above is provided except that the lithium catalyst source is added in Step (I) and the source of said gallium catalyst is added in Step (II).

In one aspect, the extent of TMCD incorporation or conversion in the final polymer can be greater than 55 mole %; or greater than 50 mole % or greater than 45 mole %; or 45 mole % or greater; greater than 40 mole %; or greater than 35 mole %; or greater than 30 mole %; or greater than 25 mole %; or greater than 20 mole %; or greater than 10 mole %.

In one aspect, the processes of making the polyesters and/or polyester compositions of the invention can comprise a batch or continuous process.

In one aspect, the processes of making the polyesters and/or polyester compositions of the invention comprise a continuous process.

In one aspect, the invention relates to a process for making a polyester comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 10 to about 50 mole % TMCD residues; and
      (ii) about 50 to about 90 mole % of residues of CHDM;
   wherein the total mole % of the dicarboxylic acid component of the final polyester is 100 mole %; and
   wherein the total mole % of the diol component of the final polyester is 100 mole %;
   wherein the molar ratio of glycol component/dicarboxylic acid component added in Step (I) is 1.01-3.0/1.0 and wherein TMCD is added in an amount from about 10 to 50 mole %, and optionally, to allow for at least 30% conversion of TMCD in the reaction, and to arrive at a final polymer having about 10 to 50 mole % TMCD residues and about 50 to 90 mole % CHDM residues;
   wherein the mixture in Step (I) is heated in the presence of:
      (i) at least two catalysts comprising lithium and gallium; and (ii) and, optionally, at least one phosphorus compound;
(II) heating the product of Step (I) at a temperature of 230° C. to 320° C. for 1 to 6 hours, under at least one pressure chosen from the range of the final pressure of Step (I) to 0.02 torr absolute, to form a final polyester;
wherein the total mole % of the dicarboxylic acid component of the final polyester is 100 mole %; and wherein the total mole % of the glycol component of the final polyester is 100 mole %;
wherein the inherent viscosity of the polyester is from 0.35 to 0.80 dL/g as determined in 60/40 (wt/wt) phenol/tetrachloroethane at a concentration of 0.25 g/50 ml at 25° C.; and
wherein the L* color value for the polyester(s) and/or polyester compositions can be from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 99, or from 70 to 95, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In one aspect, the polyesters and/or polyester compositions of the invention can comprise at least one phosphate ester whether or not present as a thermal stabilizer.

In one aspect, the polyesters and/or polyester compositions of the invention can contain no branching agent, or alternatively, at least one branching agent is added either prior to or during polymerization of the polyester.

In one aspect, the polyesters and/or polyester compositions of the invention can contain at least one branching agent without regard to the method or sequence in which it is added.

In one aspect, certain polyesters and/or polyester compositions of the invention can be amorphous or semicrystalline. In one aspect, certain polyesters of the invention can have a relatively low crystallinity. Certain polyesters of the invention can thus have a substantially amorphous morphology, meaning that the polyesters comprise substantially unordered regions of polymer.

At least one phosphorus compound useful in the invention are chosen from at least one of alkyl phosphate esters, aryl phosphate esters, mixed alkyl aryl phosphate esters, reaction products, thereof, and combinations thereof.

In one aspect, at least one phosphorus compound useful in the invention may comprise at least one aryl phosphate ester.

In one aspect, at least one phosphorus compound useful in the invention may comprise at least one unsubstituted aryl phosphate ester.

In one aspect, at least one phosphorus compound useful in the invention may comprise at least one aryl phosphate ester which is not substituted with benzyl groups.

In one aspect, at least one phosphorus compound useful in the invention may comprise at least one triaryl phosphate ester.

In one aspect, at least one phosphorus compound useful in the invention may comprise at least one triaryl phosphate ester which is not substituted with benzyl groups.

In one aspect, at least one phosphorus compound useful in the invention may comprise at least one alkyl phosphate ester.

In one aspect, at least one phosphorus compound useful in the invention may comprise triphenyl phosphate and/or Merpol A. In one embodiment, any of the polyester compositions of the invention may comprise triphenyl phosphate.

In one aspect, any of the processes described herein for making any of the polyester compositions and/or polyesters can comprise at least one mixed alkyl aryl phosphite, such as, for example, bis(2,4-dicumylphenyl)pentaerythritol diphosphite also known as Doverphos S-9228 (Dover Chemicals, CAS #154862-43-8).

In one aspect, any of the processes described herein for making any of the polyester compositions and/or polyesters can comprise at least one one phosphine oxide.

In one aspect, any of the processes described herein for making any of the polyester compositions and/or polyesters of the invention can comprise at least one salt of phosphoric acid such as, for example, KH2PO4 and Zn3(PO4)2.

It is believed that any of the processes of making the polyesters and/or polyester compositions of the invention can be used to make any of the polyesters and/or polyester compositions of the invention.

In one aspect, the pressure used in Step (I) of any of the processes of the invention can consist of at least one pressure chosen from 0 psig to 75 psig. In one embodiment, the pressure used in Step (I) of any of the processes of the invention can consist of at least one pressure chosen from 0 psig to 50 psig.

In one aspect, the pressure used in Step (II) of any of the processes of the invention can consist of at least one pressure chosen from 20 torr absolute to 0.02 torr absolute; in one embodiment, the pressure used in Step (II) of any of the processes of the invention can consist of at least one pressure chosen from 10 torr absolute to 0.02 torr absolute; in one embodiment, the pressure used in Step (II) of any of the processes of the invention can consist of at least one pressure chosen from 5 torr absolute to 0.02 torr absolute; in one embodiment, the pressure used in Step (II) of any of the processes of the invention can consist of at least one pressure chosen from 3 torr absolute to 0.02 torr absolute; in one embodiment, the pressure used in Step (II) of any of the processes of the invention can consist of at least one pressure chosen from 20 torr absolute to 0.1 torr absolute; in one embodiment, the pressure used in Step (II) of any of the processes of the invention can consist of at least one pressure chosen from 10 torr absolute to 0.1 torr absolute; in one embodiment, the pressure used in Step (II) of any of the processes of the invention can consist of at least one pressure chosen from 5 torr absolute to 0.1 torr absolute; in one embodiment, the pressure used in Step (II) of any of the processes of the invention can consist of at least one pressure chosen from 3 torr absolute to 0.1 torr absolute.

In one aspect, the molar ratio of glycol component/dicarboxylic acid component added in Step (I) of any of the processes of the invention is 1.0-3.0/1.0; in one aspect, the molar ratio of glycol component/dicarboxylic acid component added in Step (I) of any of the processes of the invention is 1.0-2.5/1.0; in one aspect, the molar ratio of glycol component/dicarboxylic acid component added in Step (I) of any of the processes of the invention is 1.0-2.0/1.0; in one aspect, the molar ratio of glycol component/dicarboxylic acid component added in Step (I) of any of the processes of the invention is 1.0-1.75/1.0; in one aspect, the molar ratio of glycol component/dicarboxylic acid component added in Step (I) of any of the processes of the invention is 1.0-1.5/1.0.

In one aspect, the molar ratio of glycol component/dicarboxylic acid component added in Step (I) of any of the processes of the invention is 1.01-3.0/1.0; in one aspect, the molar ratio of glycol component/dicarboxylic acid component added in Step (I) of any of the processes of the invention is 1.01-2.5/1.0; in one aspect, the molar ratio of glycol component/dicarboxylic acid component added in Step (I) of any of the processes of the invention is 1.01-2.0/1.0; in one aspect, the molar ratio of glycol component/dicarboxylic acid component added in Step (I) of any of the processes of the invention is 1.01-1.75/1.0; in one aspect, the molar ratio of glycol component/dicarboxylic acid component added in Step (I) of any of the processes of the invention is 1.01-1.5/1.0.

In any of the process embodiments for making the polyesters and/or polyester compositions of the invention, the heating time of Step (II) can be from 1 to 5 hours. In any of the process embodiments for making the polyesters and/or polyester compositions of the invention, the heating time of Step (II) can be from 1 to 4 hours. In any of the process embodiments for making the polyesters and/or polyester compositions of the invention, the heating time of Step (II) can be from 1 to 3 hours. In any of the process embodiments for making the polyesters and/or polyester compositions of the invention, the heating time of Step (II) can be from 1.5 to 3 hours. In any of the process embodiments for making the polyesters and/or polyester compositions of the invention, the heating time of Step (II) can be from 1 to 2 hours.

The weight (ppm) of gallium atoms and lithium atoms present in the final polyester can be measured in the final polyester of any of the aforesaid weight ratios, for example.

In one aspect, the polyesters and/or polyester compositions of the invention can be useful for non-coating compositions, non-adhesive compositions, thermoplastic polyester compositions, articles of manufacture, shaped articles, thermoplastic shaped articles, molded articles, extruded articles, injection molded articles, blow molded articles, film and/or sheet (for example, calendered, cast, or extruded), thermoformed film or sheet, containers, and/or bottles (for example, baby bottles or sports bottles or water bottles).

In one aspect, the polyester and/or polyester compositions are useful in shaped articles, including, but not limited to, extruded, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, drinkware, medical parts, sheet and/or fibers.

In one aspect, the polyesters and/or polyester compositions useful in the invention can be used in various types of film and/or sheet, including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

In one aspect, the invention is related to thermoformed film(s) and/or sheet(s) comprising the polyester(s) and/or polyester compositions of the invention.

In one aspect, the invention is related to articles of manufacture which incorporate the thermoformed film and/or sheet of the invention.

In one aspect, any of the processes of making the polyesters useful in the invention and described herein or known by one of ordinary skill in the art may be used to make any of the polyesters and/or polyester composition of the invention.

In one aspect, any of the polyesters and/or polyester compositions described herein are also considered within the scope of this invention, regardless of which process is used to make them, and any products made therefrom.

In one aspect, the invention is related to articles of manufacture, e.g., shaped articles, that comprise any of the polyesters and/or polyester compositions of the invention.

### DETAILED DESCRIPTION OF THE INVENTION

The present invention can be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

It is believed that certain polyesters and/or polyester composition(s) of the invention formed from terephthalic acid, an ester thereof, and/or combinations thereof, TMCD and CHDM, and, further comprising certain catalysts and, optionally, stabilizers, reaction products thereof, and combinations thereof, can have a combination of one or more, two or more, or three or more, of good notched Izod impact strength, good inherent viscosities, good glass transition temperature (Tg), good flexural modulus, good tensile strength, good clarity, good color, good dish washer durability, good TMCD incorporation and good/improved melt and/or thermal stability.

In one embodiment, copolyesters containing 2,2,4,4-tetramethyl-1,3-cyclobutanediol and CHDM over a range of compositions can be prepared with at least one lithium catalyst and at least one gallium catalyst.

The present invention relates to polyesters based on terephthalic acid or esters thereof, TMCD and CHDM catalyzed by certain catalyst types that provide improved properties (as discussed herein). In certain embodiments, at least one lithium catalyst and at least one gallium catalyst, can result in good TMCD incorporation, reactivity to achieve desired inherent viscosity (IV) over a broad compositional range and/or good color.

When lithium is added to the polyesters and/or polyester compositions and/or process of making the polyesters and/or polyester compositions of the invention, it is added to the process of making the polyester in the form of a lithium compound. The amount of the lithium compound added to the polyesters and/or polyester compositions of the invention and/or processes of the invention can be measured in the form of lithium atoms present in the final polyester, for example, by weight measured in ppm.

When gallium is added to the polyesters and/or polyester compositions and/or process of making the polyesters of the invention, it is added to the process of making the polyester in the form of an gallium compound. The amount of the gallium compound added to the polyesters of the invention and/or polyester compositions of the invention and/or processes of the invention can be measured in the form of gallium atoms present in the final polyester, for example, by weight measured in ppm.

When phosphorus is added to the polyesters and/or polyester compositions and/or process of making the polyesters of the invention, it is added to the process of making the polyester in the form of a phosphorus compound. In one embodiment, this phosphorus compound can comprise at least one phosphate ester(s). The amount of phosphorus compound, [for example, phosphate ester(s)] added to the polyesters of the invention and/or polyester compositions of the invention and/or processes of the invention can be measured in the form of phosphorus atoms present in the final polyester, for example, by weight measured in ppm.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. Alternatively, the difunctional carboxylic acid can be a hydroxy carboxylic acid such as, for example, p-hydroxybenzoic acid, and the difunctional hydroxyl compound can be an aromatic nucleus bearing 2 hydroxyl substituents such as, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues can be derived from a dicarboxylic acid monomer or its associated acid halides, esters, salts, anhydrides, and/or combinations thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or combinations thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or combinations thereof or residues thereof useful in a reaction process with a diol to make polyester.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, can be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 25 mole % TMCD, based on the total diol residues, means the polyester contains mole % TMCD residues out of a total of 100 mole % diol residues. Thus, there are 25 moles of TMCD residues among every 100 moles.

In certain embodiments, the invention includes polyester compositions comprising at least one polyester comprising: (a) a dicarboxylic acid component comprising: (i) 70 to 100 mole % terephthalic acid and/or dimethyl terephthalate residues; and (ii) about 0 to about 30 mole % of aromatic and/or aliphatic dicarboxylic acid residues having up to 20 carbon atoms; and (b) a glycol component comprising about 10 to about 50 mole % TMCD residues and about 50 to about 90 mole % CHDM residues and optionally, residues of at least one modifying glycol.

In one embodiment, the polyesters and/or polyester compositions of the invention can comprise residues of TMCD in the amount of from about 10 to about 45 mole %, or from about 10 to about 40 mole %, or from about 10 to about 30 mole %, or from about 15 to about 45 mole %, or from about 15 to about 40 mole %, or from about 20 to about 50 mole %, or from about 20 to about 45 mole %, or from about 20 to about 40 mole %, or from about 20 to about 30 mole %, or from about 25 to about 50 mole %, or from about 25 to about 45 mole %, or from about 25 to about 40 mole %, or from about 30 to about 50 mole %, or from about 30 to about 45 mole %, or from about 30 to about 40 mole %. Modifying glycols can comprise the remaining mole percentages.

In one embodiment, the polyesters and/or polyester compositions of the invention can comprise CHDM residues in the amount of from about 55 to about 90 mole %, of from about 60 to about 90 mole %, of from about 70 to about 90 mole %, or from about 55 to about 85 mole %, or from about 60 to about 85 mole %, or from about 50 to about 80 mole %, or from about 55 to about 80 mole %, or from about 60 to about 80 mole, or from about 70 to about 80 mole %, or from about 50 to about 75 mole %, or from about 55 to about 75 mole %, or from about 60 to about 75 mole %, or from about 60 to about 70 mole %, or from about 50 to about 70 mole %, or from about 60 to about 70 mole %.

In one embodiment, the polyesters and/or polyester compositions of the invention can comprise residues of TMCD in the amount of 20 to 45 mole % and residues of CHDM in the amount of 55 to 80 mole %, or residues of TMCD in the amount of 20 to 40 mole % and residues of CHDM in the amount of 60 to 80 mole %, or residues of TMCD in the amount of 20 to 35 mole % and residues of CHDM in the amount of 65 to 80 mole %, or 25 to 45 mole % and residues of CHDM in the amount of 55 to 75 mole %, or residues of TMCD in the amount of 25 to 40 mole % and residues of CHDM in the amount of 60 to 75 mole %, or residues of TMCD in the amount of 25 to 35 mole % and residues of CHDM in the amount of 65 to 75 mole %; or residues of TMCD in the amount of 30 to 35 mole % and residues of CHDM in the amount of 65 to 70 mole %.

In one embodiment, the polyesters and/or polyester compositions of the invention, wherein the molar ratio of TMCD:CHDM is from 1:9 to 1:1, or from 1:4 to 1:1, or from or from 1:3 to 1:1.5, or from 1:3 to 1:1, or from 1:2 to 1:1, or from 1:1.5 to 1:1; or 1:1.

For the desired polyester, the molar ratio of cis/trans TMCD can vary from the pure form of each and combinations thereof. In certain embodiments, the molar percentages for cis and/or trans 2,2,4,4,-tetramethyl-1,3-cyclobutanediol are greater than 50 mole % of cis-TMCD and less than 50 mole % of trans-TMCD, or greater than 70 mole % of cis-TMCD and less than mole % of trans-TMCD, or greater than 75 mole % of cis-TMCD and less than 25 mole % of trans-TMCD, or greater than 80 mole % of cis-TMCD and less than 20 mole % of trans-TMCD, or greater than 90 mole % of cis-TMCD and less than 10 mole % of trans-TMCD, or greater than 95 mole % of cis-TMCD and less than 5 mole % of trans-TMCD, wherein the total mole percentages for cis- and trans-TMCD is equal to 100 mole %.

In one embodiment, the extent of TMCD incorporation or conversion in the final polymer can be greater than 55 mole %; or greater than 50 mole % or greater than 45 mole %; or 45 mole % or greater; greater than 40 mole %; or greater than 35 mole %; or greater than 30 mole %; or greater than mole %; or greater than 20 mole %; or greater than 10 mole %.

In another embodiment, the polyesters and/or polyester compositions of the invention can comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

In one embodiment, the polyesters of the polyester compositions of the invention can optionally comprise modifying glycol residues.

In one embodiment, the modifying glycols can comprise diethylene glycol, 1,2-propanediol, 1,3-propanediol, 2-methyl-1,3-propanediol, ethylene glycol, 1,4-butanediol, 1,5-pentanediol, 1,6-hexanediol, p-xylene glycol, neopentyl glycol, isosorbide, polytetramethylene glycol, or combinations thereof.

In one embodiment, the polyesters and/or polyester compositions of the invention can comprise less than 40 mole %, or less than 30 mole %, or less than 25 mole %, or less than 20 mole %, or less than 15 mole %, or less than 10 mole %, or less than 5 mole %, or less than 2 mole %, or 0 mole % of residues of at least one modifying glycol, e.g., ethylene glycol residues.

In one embodiment, the polyesters and/or polyester compositions of the invention can comprise residues of ethylene glycol or can comprise no residues of ethylene glycol.

In one embodiment, the polyesters and/or polyester compositions of the invention can comprise residues or no residues of at least one of 1,3-propanediol, 1,4-butanediol, and neopentyl glycol.

In one embodiment, the polyesters and/or polyester compositions of the invention can comprise no neopentyl glycol residues and/or no 1,4-butanediol residues.

In certain embodiments of the invention, the polyesters can contain a second modifying glycol having from 3 to 16 carbon atoms. In certain embodiments, the polyester contains no other added modifying glycols. It should be understood that some other glycol residues can be formed in situ during processing.

In one embodiment, terephthalic acid can be used as the starting material. In another embodiment, dimethyl terephthalate can be used as the starting material. In yet another embodiment, combinations of terephthalic acid and dimethyl terephthalate can be used as the starting material and/or as an intermediate material.

In certain embodiments, terephthalic acid or an ester thereof, such as, for example, dimethyl terephthalate or a combination of terephthalic acid residues and an ester thereof can make up a portion or all of the dicarboxylic acid component used to form the polyesters of the invention. In certain embodiments, terephthalic acid residues can make up a portion or all of the dicarboxylic acid component used to form the polyesters of the invention. In certain embodiments, higher amounts of terephthalic acid can be used in order to produce a higher impact strength polyester. For purposes of this disclosure, the terms “terephthalic acid” and “dimethyl terephthalate” are used interchangeably herein. In one embodiment, dimethyl terephthalate can be part or all of the dicarboxylic acid component used to make the polyesters of the present invention. In certain embodiments, ranges of from 70 to 100 mole %; or 80 to 100 mole %; or 90 to 100 mole %; or 99 to 100 mole %; or 100 mole % terephthalic acid and/or dimethyl terephthalate and/or combinations thereof can be used.

In addition to terephthalic acid, the dicarboxylic acid component of the polyesters of the invention can comprise less than 30 mole %, or less than mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole/o, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole % of one or more modifying aromatic and/or aliphatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that can be used in the present invention include but are not limited to those having up to 20 carbon atoms, and which can be linear, para-oriented, or symmetrical. Examples of modifying aromatic dicarboxylic acids which can be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters of the invention can be further modified with less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to mole %, or 0.1 to 5 mole %, or 1 or 5, or 0.01 to 1 mole %, or 0.1 to 1 mole %, or 5 to 10 mole %, or 0 mole % of one or more aliphatic dicarboxylic acids containing 2-16 carbon atoms, such as, for example, cyclohexanedicarboxylic, malonic, succinic, glutaric, adipic, pimelic, suberic, azelaic and dodecanedioic dicarboxylic acids. Certain embodiments can also comprise 0.01 to 10 mole %, such as 0.1 to 10 mole %, 1 or 10 mole %, or 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the invention.

Esters of terephthalic acid and the other modifying dicarboxylic acids or their corresponding esters and/or salts can be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, the polyesters of the invention can comprise:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic and/or aliphatic dicarboxylic acid residues having up to 20 carbon atoms;
   (b) a glycol component comprising:
      (i) about 15 to about 45 mole % of TMCD residues;
      (ii) about 55 to about 85 mole % residues of CHDM;
wherein the total mole % of the dicarboxylic acid component is 100 mole %,
wherein the total mole % of the diol component is 100 mole %; and
(2) lithium atoms, gallium atoms, and less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms, and/or titanium atoms;
wherein the inherent viscosity is from 0.35 to 0.75 dL/g, or 0.40 to 0.75, or 0.45 to 0.75 dL/g, or 0.50 to 0.75 dL/g, as determined in 60/40 (wt/wt) phenol/tetrachloroethane at a concentration of 0.5 g/100 ml at 25° C., and having a b* value of less than 15, or less than 14, or less than 13, or less than 12, or less than 11, or less than 10, or less than 9, or less than 8.5, or less than 8, or less than 7, or less than 6, or less than 5, or from 1 to 5, and a L* value of from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 99, or from 70 to 95, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination). In some embodiments, the a* value can also be less than 1, or less than 0, or less than −1, or less than −1.5, or less than −2.

In one embodiment, for all of the polyesters and/or polyester compositions of the invention, the inherent viscosity can be from 0.35 to 1.2 dL/g, or from 0.35 to 0.80 dL/g, or from 0.35 to 0.75 dL/g, or 0.35 to 0.70 dL/g, or 0.35 to 0.60 dL/g, or 0.40 to 0.75 dL/g, or 0.40 to 0.70 dL/g, or 0.40 to 0.65 dL/g, or 0.40 to 0.60 dL/g, or 0.45 to 0.75 dL/g, or 0.45 to 0.70 dL/g, or 0.45 to 0.65 dL/g, or 0.45 to 0.60 dL/g, or from 0.50 to 1.2 dL/g, or from 0.50 to 0.80 dL/g, or from 0.50 to 0.75 dL/g, or 0.50 to 0.70 dL/g, or 0.50 to 0.65 dL/g, or 0.50 to 0.60 dL/g, or from 0.55 to 0.75 dL/g, or from 0.55 to 0.70 dL/g, or from 0.60 to 0.75 dL/g, as determined in 60/40 (wt/wt) phenol/tetrachloroethane at a concentration of 0.5 g/100 ml at 25° C.

In some embodiments, the polyesters according to the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent can be added prior to and/or during and/or after the polymerization of the polyester. In embodiments, the polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer can be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters and/or polyester compositions of the invention can comprise at least one chain extender. Suitable chain extenders include, but are not limited to, multifunctional (including, but not limited to, bifunctional) isocyanates, multifunctional epoxides, including for example epoxylated novolacs, and phenoxy resins. In certain embodiments, chain extenders can be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

In one embodiment, the phosphorus compound(s) can be an organic compound such as, for example, a phosphorus acid ester containing halogenated or non-halogenated organic substituents. In certain embodiments, the phosphorus compound(s) can comprise a wide range of phosphorus compounds, for example, phosphines, phosphites, phosphinites, phosphonites, phosphinates, phosphonates, phosphine oxides, and phosphates.

Examples of phosphorus compounds that can be useful in the invention can include tributyl phosphate, triethyl phosphate, tri-butoxyethyl phosphate, t-butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl rnethylphosphonite, dimethyl cresylphosphonite, methyl dirriethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine. In one embodiment, triphenyl phosphine oxide is excluded as a thermal stabilizer in the process(es) of making the polyesters of the invention and/or in the polyester composition(s) of the invention.

In one embodiment, phosphorus compounds useful in the invention can be any of the previously described phosphorus-based acids wherein one or more of the hydrogen atoms of the acid compound (bonded to either oxygen or phosphorus atoms) are replaced with alkyl, branched alkyl, substituted alkyl, alkyl ethers, substituted alkyl ethers, alkyl-aryl, alkyl-substituted aryl, aryl, substituted aryl, and combinations thereof. In another embodiment, phosphorus compounds useful in the invention, include but are not limited to, the above described compounds wherein at least one of the hydrogen atoms bonded to an oxygen atom of the compound is replaced with a metallic ion or an ammonium on.

The esters can contain alkyl, branched alkyl, substituted alkyl, alkyl ethers, aryl, and/or substituted aryl groups. The esters can also have at least one alkyl group and at least one aryl group. The number of ester groups present hi the particular phosphorus compound can vary from zero up to the maximum allowable based on the number of hydroxyl groups present on the phosphorus compound used. For example, an alkyl phosphate ester can include one or more of the mono-, di-, and tri alkyl phosphate esters; an aryl phosphate ester includes one or more of the mono-, di-, and tri aryl phosphate esters; and an alkyl phosphate ester and/or an aryl phosphate ester also include, but are not limited to, mixed alkyl aryl phosphate esters having at least one alkyl and one aryl group.

In one embodiment, the phosphorus compounds useful in the invention include but are not limited to alkyl, aryl or mixed alkyl aryl esters or partial esters of phosphoric acid, phosphorus acid, phosphinic acid, phosphonic acid, or phosphonous acid. The alkyl or aryl groups can contain one or more substituents.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, diphosphates, salts of phosphoric acid, phosphine oxides, and mixed aryl alkyl phosphites, reaction products thereof, and combinations thereof. The phosphate esters include esters in which the phosphoric acid is fully esterified or only partially esterified.

In one embodiment, for example, the phosphorus compounds useful in the invention can include at least one phosphate ester.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, reaction products thereof, and combinations thereof. The phosphate esters include esters in which the phosphoric acid is fully esterified or only partially esterified.

In one embodiment, for example, the phosphorus compounds useful in the invention can include at least one phosphate ester.

In another embodiment, the phosphate esters useful in the invention can include but are not limited to alkyl phosphate esters, aryl phosphate esters, mixed alkyl aryl phosphate esters, and/or combinations thereof.

In certain embodiments, the phosphate esters useful in the invention are those where the groups on the phosphate ester include are alkyl, alkoxy-alkyl, phenyl, or substituted phenyl groups. These phosphate esters are generally referred to herein as alkyl and/or aryl phosphate esters. Certain preferred embodiments include trialkyl phosphates, triaryl phosphates, alkyl diaryl phosphates, dialkyl aryl phosphates, and combinations of such phosphates, wherein the alkyl groups are preferably those containing from 2 to 12 carbon atoms, and the aryl groups are preferably phenyl.

Representative alkyl and branched alkyl groups are preferably those containing from 1-12 carbon atoms, including, but not limited to, ethyl, propyl, isopropyl, butyl, hexyl, cyclohexyl, 2-ethylhexyl, octyl, decyl and dodecyl. Substituted alkyl groups include, but are not limited to, those containing at least one of carboxylic acid groups and esters thereof, hydroxyl groups, amino groups, keto groups, and the like.

Representative of alkyl-aryl and substituted alkyl-aryl groups are those wherein the alkyl portion contains from 1-12 carbon atoms, and the aryl group is phenyl or substituted phenyl wherein groups such as alkyl, branched alkyl, aryl, hydroxyl, and the like are substituted for hydrogen at any carbon position on the phenyl ring. Preferred aryl groups include phenyl or substituted phenyl wherein groups such as alkyl, branched alkyl, aryl, hydroxyl and the like are substituted for hydrogen at any position on the phenyl ring.

In one embodiment, the phosphate esters useful in the invention include but are not limited to dibutylphenyl phosphate, triphenyl phosphate, tricresyl phosphate, tributyl phosphate, tri-2-ethylhexyl phosphate, trioctyl phosphate, and/or combinations thereof, including particularly combinations of tributyl phosphate and tricresyl phosphate, and combinations of isocetyl diphenyl phosphate and 2-ethylhexyl diphenyl phosphate.

In one embodiment, at least one phosphorus compound useful in the invention comprises at least one aryl phosphate ester.

In one embodiment, at least one phosphorus compound useful in the invention comprises at least one unsubstituted aryl phosphate ester.

In one embodiment, at least one phosphorus compound useful in the invention comprises at least one aryl phosphate ester which is not substituted with benzyl groups.

In one embodiment, any of the phosphorus compounds useful in the invention may comprise at least one alkyl phosphate ester.

In one embodiment, the phosphate esters useful in the invention as thermal stabilizers and/or color stabilizers include but are not limited to, at least one of the following: trialkyl phosphates, triaryl phosphates, alkyl diaryl phosphates, and mixed alkyl aryl phosphates.

In one embodiment, the phosphate esters useful in the invention as thermal stabilizers and/or color stabilizers include but are not limited to, at least one of the following: triaryl phosphates, alkyl diaryl phosphates, and mixed alkyl aryl phosphates.

In one embodiment, the phosphate esters useful as thermal stabilizers and/or color stabilizers in the invention can include but are not limited to, at least one of the following: triaryl phosphates and mixed alkyl aryl phosphates.

In one embodiment, at least one phosphorus compound useful in the invention can comprise, but is not limited to, triaryl phosphates, such as, for example, triphenyl phosphate. In one embodiment, at least one thermal stabilizer comprises, but is not limited to Merpol A. In one embodiment, at least one thermal stabilizer useful in the invention comprises, but is not limited to, at least one of triphenyl phosphate and Merpol A. Merpol A is a phosphate ester commercially available from Stepan Chemical Co and/or E.I. duPont de Nemours & Co. The CAS Registry number for Merpol A is believed to be CAS Registry #37208-27-8.

In one embodiment, any of the phosphorus compounds useful in the invention may comprise at least one triaryl phosphate ester which is not substituted with benzyl groups.

In one embodiment, the polyesters and/or processes of the invention may comprise 2-ethylhexyl diphenyl phosphate.

In one embodiment, any of the processes described herein for making any of the polyesters and/or polyesters can comprise at least one mixed alkyl aryl phosphite, such as, for example, bis(2,4-dicumylphenyl)pentaerythritol diphosphite also known as Doverphos S-9228 (Dover Chemicals, CAS #15486243-8).

In one embodiment, any of the processes described herein for making any of the polyester compositions and/or polyesters can comprise at least one phosphine oxide.

In one embodiment, any of the processes described herein for making any of the polyester compositions and/or polyesters can comprise at least one salt of phosphoric acid such as, for example, KH2PO4 and Zn3(PO4)2.

The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive.

In one embodiment of the invention, the phosphorus compounds useful in the invention may act as thermal stabilizers. In one embodiment of the invention, the phosphorus compounds useful in the invention may not act as a thermal stabilizer but may act as a color stabilizer. In one embodiment of the invention, the phosphorus compounds useful in the invention may act as both a thermal stabilizer and a color stabilizer.

In one embodiment, amounts of the phosphate ester of the invention added during polymerization are chosen from the following: 10 to 200 ppm based on the total weight of the polyester and/or polyester composition and as measured in the form of phosphorus atoms in the final polyester. In embodiments of the invention, phosphorous can be present in an amount of 10 to 100, or 10 to 80, or 10 to 60, or 10 to 55, or 15 to 55, or 18 to 52, or 20 to 50 ppm, based on the total weight of the polyester and/or polyester composition and as measured in the form of phosphorus atoms in the final polyester.

In one embodiment, the catalyst system contains at least one lithium compound. In one embodiment, the lithium compound can be used in either the esterification reaction or the polycondensation reaction or both reactions. In one embodiment, the catalyst system contains at least one lithium compound used in the esterification reaction. In one embodiment, the catalyst system contains at least one lithium compound used in the polycondensation reaction.

The lithium-containing compounds useful in this invention include any compound containing lithium including but not limited to at least one of lithium carbonate, lithium acetate, lithium benzoate, lithium succinate, lithium acetylacetonate, lithium methoxide, lithium oxalate, lithium nitrate, lithium ethoxide, lithium hydroxide, lithium hydride, lithium glycoxide, alkyl lithium, lithium gallium hydride, lithium borohydride, lithium oxide.

In one embodiment, the polyesters and/or polyester compositions of the invention comprise at least one lithium source comprising at least one of lithium acetate, lithium acetylacetonate, lithium hydroxide, lithium carbonate, lithium oxalate, or lithium nitrate.

In one embodiment, the polyesters and/or polyester compositions of the invention comprise at least one lithium source which is lithium acetylacetonate.

In one embodiment, the polyesters and/or polyester compositions of the invention can comprise lithium atoms in the amount of from 20 to 1000 ppm, or from 20 to 750 ppm, or from 20 to 500 ppm, or from 20 to 300 ppm, or from 20 to 275 ppm, or from 20 to 250 ppm, or from 20 to 200 ppm, or from 20 to 175 ppm, or from 20 to 150 ppm, or from 20 to 125 ppm, or from 20 to 120 ppm, or from 20 to 115 ppm, or from 20 to 110 ppm, or from 20 to 100 ppm, or from 25 to 1000 ppm, or from 25 to 750 ppm, or from 25 to 500 ppm, or from 25 to 300 ppm, or from 25 to 275 ppm, or from 25 to 250 ppm, or from 25 to 200 ppm, or from 25 to 175 ppm, or from 25 to 150 ppm, or from 25 to 125 ppm, or from 25 to 120 ppm, or from 25 to 115 ppm, or from 25 to 110 ppm, or from 25 to 100 ppm, or from 30 to 1000 ppm, or from 30 to 750 ppm, or from to 500 ppm, or from 30 to 300 ppm, or from 30 to 275 ppm, or from 30 to 250 ppm, or from 30 to 200 ppm, or from 30 to 175 ppm, or from 30 to 150 ppm, or from 30 to 125 ppm, or from 30 to 120 ppm, or from 30 to 115 ppm, or from 30 to 110 ppm, or from 30 to 100 ppm, or from 40 to 1000 ppm, or from to 750 ppm, or from 40 to 500 ppm, or from 40 to 300 ppm, or from 40 to 275 ppm, or from 40 to 250 ppm, or from 40 to 200 ppm, or from 40 to 175 ppm, or from 40 to 150 ppm, or from 40 to 125 ppm, or from 40 to 120 ppm, or from 40 to 115 ppm, or from 40 to 110 ppm, or from 30 to 100 ppm, or from 50 to 1000 ppm, or from 50 to 750 ppm, or from 50 to 500 ppm, or from 50 to 300 ppm, or from 50 to 275 ppm, or from 50 to 250 ppm, or from 50 to 200 ppm, or from 50 to 175 ppm, or from 50 to 150 ppm, or from 50 to 140 ppm, or from 50 to 130 ppm, or from 50 to 125 ppm, or from 50 to 120 ppm, or from 50 to 115 ppm, or from 50 to 110 ppm, or from 50 to 100 ppm, or from 60 to 1000 ppm, or from 60 to 750 ppm, or from 60 to 500 ppm, or from 60 to 300 ppm, or from 60 to 275 ppm, or from 60 to 250 ppm, or from 60 to 200 ppm, or from 60 to 175 ppm, or from 60 to 150 ppm, or from 60 to 140 ppm, or from 60 to 130 ppm, or from 60 to 125 ppm, or from 60 to 120 ppm, or from 60 to 115 ppm, or from 60 to 110 ppm, or from 60 to 100 ppm, or from 75 to 1000 ppm, or from 75 to 750 ppm, or from 75 to 500 ppm, or from 75 to 300 ppm, or from 75 to 250 ppm, or from 75 to 200 ppm, or from 75 to 175 ppm, or from 75 to 150 ppm, or from 75 to 140 ppm, or from 75 to 130 ppm, or from 75 to 125 ppm, or from 75 to 120 ppm, or from 75 to 115 ppm, or from 75 to 110 ppm, or from 75 to 100 ppm, or from 80 to 1000 ppm, or from 80 to 750 ppm, or from 80 to 500 ppm, or from 80 to 300 ppm, or from 80 to 275 ppm, or from 80 to 250 ppm, or from 80 to 200 ppm, or from 80 to 175 ppm, or from 80 to 150 ppm, or from 80 to 140 ppm, or from 80 to 130 ppm, or from 80 to 125 ppm, or from 80 to 120 ppm, or from 80 to 115 ppm, or from 90 to 1000 ppm, or from 90 to 750 ppm, or from 90 to 500 ppm, or from 90 to 300 ppm, or from 90 to 275 ppm, or from 90 to 250 ppm, or from 90 to 200 ppm, or from 90 to 175 ppm, or from 90 to 150 ppm, or from 90 to 140 ppm, or from 90 to 130 ppm, or from 90 to 125 ppm, or from 90 to 120 ppm, or from 90 to 115 ppm, or from 100 to 1000 ppm, or from 100 to 750 ppm, or from 100 to 500 ppm, or from 100 to 400 ppm, or from 100 to 300 ppm, or from 100 to 275 ppm, or from 100 to 250 ppm, relative to the mass of final polyester being prepared.

In one embodiment, the amount of lithium atoms present in the polyesters and/or polyester compositions of the invention can generally range from at least 5 ppm, or at least 8 ppm, or at least 10 ppm, or at least 15 ppm, or at least 20 ppm, or at least 25 ppm, or at least 30 ppm, or at least 35 ppm, or at least 40 ppm, or at least 45 ppm, or at least 50 ppm, or at least 75 ppm, or at least 80 ppm, or at least 90 ppm, or less than 150 or less than 125 ppm, and less than 115 ppm, based, relative to the mass of final polyester being prepared.

In one aspect, the range of lithium atoms by weight can be from 50 ppm to 300 ppm, or from 50 ppm to 250 ppm, or from 50 to 200 ppm, or from 50 ppm to 150 ppm, or from 50 ppm to 125 ppm, or from 50 ppm to 115 ppm, or from 60 ppm to 300 ppm, or from 60 ppm to 250 ppm, or from 60 to 200 ppm, or from 60 ppm to 150 ppm, or from 60 ppm to 125 ppm, or from 60 ppm to 115 ppm, or from 75 ppm to 300 ppm, or from 75 ppm to 250 ppm, or from 75 to 200 ppm, or from 75 ppm to 150 ppm, or from 75 ppm to 125 ppm, or from 75 ppm to 115 ppm, relative to the mass of the final polyester.

In one embodiment, the catalyst combination contains at least one gallium compound. In one embodiment, the gallium compound can be used in either the esterification reaction or the polycondensation reaction or both reactions. In one embodiment, the catalyst system contains at least one gallium compound used in the esterification reaction. In one embodiment, the catalyst combination contains at least one gallium compound used in the polycondensation reaction.

In one embodiment, the polyesters can comprise at least one gallium source which is catalytically active. These gallium compounds can include gallium compounds with at least one organic substituent.

Suitable examples of gallium compounds can comprise at least one the carboxylic acid salts of gallium such as gallium acetate (if solubilized), gallium benzoate, gallium sulfate, gallium lactate, gallium laurate, gallium stearate, gallium alcoholates, gallium ethylate, gallium isopropylate (also known as gallium isopropoxide), gallium trin-butyrate, gallium tri-tert-butyrate, mono-sec-butoxygallium diisopropylate, and gallium chelates in which the alkoxy group of an gallium alcoholate is partially or wholly substituted by a chelating agents such as an alkyl acetoacetate or acetylacetone such as ethyl acetoacetate gallium diisopropylate, gallium tris(ethyl acetoacetate), alkyl acetoacetate, gallium diisopropylate, gallium monoacetylacetate bis(ethyl acetoacetate), gallium tris(acetyl acetate), or gallium acetylacetonate.

In one embodiment, the polyesters and/or polyester compositions of the invention can contain gallium hydroxide, gallium acetylacetonate, gallium acetate, gallium isopropoxide or gallium sulfate.

In one embodiment, the polyesters and/or polyester compositions of the invention can comprise at least one gallium source selected from gallium acetylacetonate and gallium isopropoxide.

In one embodiment, the polyesters and/or polyester compositions of the invention can comprise at least one gallium source selected from gallium acetylacetonate.

In one embodiment, the amount of gallium atoms present in the polyesters and/or polyester compositions of the invention can generally range from 50 to 1000 ppm, or from 50 to 750 ppm, or from 50 to 500 ppm, or from 50 to 300 ppm, or from 50 to 250 ppm, or from 50 to 200 ppm, or from 60 to 1000 ppm, or from 60 to 750 ppm, or from 60 to 500 ppm, or from 60 to 300 ppm, or from 60 to 250 ppm, or from 60 to 200 ppm, or from 75 to 1000 ppm, or from 75 to 750 ppm, or from 75 to 500 ppm, or from 75 to 300 ppm, or from 75 to 250 ppm, or from 75 to 200 ppm, or from 100 to 1000 ppm, or from 100 to 750 ppm, or from 100 to 500 ppm, or from 100 to 400 ppm, or from 100 to 300 ppm, or from 100 to 250 ppm, or from 100 to 200, or from 150 to 1000 ppm, or from 150 to 750 ppm, or from 150 to 500 ppm, or from 150 to 400 ppm, or from 150 to 300 ppm, or from 150 to 250 ppm, or from 200 to 1000 ppm, or from 200 to 750 ppm, or from 200 to 500 ppm, or from 200 to 400 ppm, or from 200 to 300 ppm, or from 200 to 250 ppm, or from 250 to 1000 ppm, or from 250 to 750 ppm, or from 250 to 500 ppm, or from 250 to 475 ppm, or from 250 to 450 ppm, or from 250 to 400 ppm, or 250 to 375 ppm, or from 250 to 350 ppm, or from 200 to 300 ppm, or from 200 to 250 ppm, or from 275 to 1000 ppm, or from 275 to 750 ppm, or from 275 to 500 ppm, or from 275 to 475 ppm, or from 275 to 450 ppm, or from 275 to 425 ppm, or from 275 to 400 ppm, or from 275 to 350 ppm, or from 300 to 1000 ppm, or from 300 to 750 ppm, or from 300 to 500 ppm, or from 300 to 475 ppm, or from 300 to 450 ppm, or from 300 to 425 ppm, or from 300 to 400 ppm, or from 325 to 1000 ppm, or from 325 to 750 ppm, or from 325 to 500 ppm, or from 325 to 475 ppm, or from 325 to 450 ppm, or from 325 to 425 ppm, relative to the mass of final polyester being prepared.

In one embodiment, the polyesters and/or polyester compositions of the invention wherein the ratio of lithium atoms to gallium atoms in ppm relative to the mass of final polyester being prepared from 0.50-1:5 to 5:1, or from 0.50-1:4 to 4:1, or from 0.50-1:3 to 3:1, or from 0.50:1 to 1:5, or from 0.50-1 to 1:4, or from 0.60-1:5 to 5:1, or from 0.60-1:4 to 4:1, or from 0.60-1:3 to 3:1, or from 0.60:1 to 1:5, or from 0.60-1 to 1:4, or from 0.70-1:5 to 5:1, or from 0.70-1:4 to 4:1, or from 0.70-1:3 to 3:1, or from 0.70-1:2 to 2:1, or from 0.70-1.2 to 1:4, or from 0.75-1:5 to 5:1, or from 0.75-1.2 to 1:4 to 4:1, or from 0.75-1:3 to 3:1, or from 0.75-1:2 to 2:1, or from 0.75-1.0 to 1:4, or from 0.80:1.2 to 1:4, or from 0.80-1:5 to 5:1, or from 0.80-1:5 to 5:1, or from 0.80-1.2 to 1:4 to 4:1, or from 0.80-1:3 to 3:1, or from 0.80-1:2 to 2:1, or from 0.80-1.2 to 1:4.

In one embodiment, the polyesters and/or polyester compositions of the invention wherein the ratio of lithium atoms to gallium atoms in ppm relative to the mass of final polyester being prepared is from 1:5 to 5:1, 1:4 to 4:1, or from 1:3 to 3:1, or from 1:2 to 2:1.

In one embodiment, the polyesters and/or polyester compositions of the invention can have a total of catalyst metal atoms present in the composition in the range of from 200 to 1000 ppm, or from 200 to 900 ppm, or from 200 to 800 ppm, or from 200 to 750 ppm, or from 200 to 700 ppm, 200 to 600 ppm, or from 200 to 500 ppm, or from 200 to 400 ppm, or from 200 to 300 ppm, or 250 to 600 ppm, or from 250 to 500 ppm, or from 250 to 450 ppm, or from 250 to 400 ppm, or from 300 to 600 ppm, or from 300 to 450 ppm, or from 350 to 450 ppm, or from 300 to 400 ppm, or from 350 to 450 ppm, or from 300 to 500 ppm, or from 300 to 450 ppm, relative to the mass of final polyester being prepared.

In one embodiment, suitable catalysts for use in the processes of the invention to make the polyesters and/or polyester compositions of the invention include at least one lithium compound and one gallium compound. In certain embodiments, other catalysts could possibly be used in the invention in combination with the at least one lithium compound and the at least one gallium compound. Other catalysts may include, but are not limited to, those based on zinc, antimony, cobalt, magnesium, germanium.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of titanium atoms and/or tin atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of manganese atoms.

In one embodiment, the polyesters and/or polyester compositions of the invention can less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of zinc atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of titanium atoms, tin atoms, and/or manganese atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of titanium atoms, tin atoms, and/or zinc atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of aluminum atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of titanium atoms, tin atoms, manganese atoms, magnesium atoms, cobalt atoms, calcium atoms, cadmium atoms, and/or zinc atoms and can exclude any combination of these or can exclude all of these.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of manganese atoms, zinc atoms, calcium atoms, and/or cadmium atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of Group II metals of the Periodic Table.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of germanium atoms and/or antimony atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of sodium atoms and/or potassium atoms.

In one embodiment, the polyesters and/or polyester compositions of the invention can have a Tg of from 85 to 130° C., or from 100 to 130° C., or from 100 to 125° C., or from 100 to 120° C. The glass transition temperature (T g) of the polyesters is determined using a TA DSC 2920 from Thermal Analyst Instrument at a scan rate of 20° C./min.

In one embodiment, the polyesters and/or polyester compositions of the invention can include polyesters having a degree of polymerization of from 0.01 to 300, or 0.01 to 250, or 0.01 to 200, or 0.01 to 150, or 0.01 to 130, or 0.01 to 120, or 0.10 to 300, or 0.10 to 250, or 0.10 to 200, or 0.10 to 150, or 0.10 to 130, or 0.10 to 120, or 0.20 to 300, or 0.20 to 250, or 0.20 to 200, or 0.20 to 150, or 0.20 to 130, or 0.20 to 120, or 0.15 to 300, or 0.15 to 250, or 0.15 to 200, or 0.15 to 150, or 0.15 to 130, or 0.15 to 120.

It is contemplated that compositions useful in the invention can possess at least one of the inherent viscosity ranges described herein and at least one of the monomer ranges for the compositions described herein unless otherwise stated. It is also contemplated that compositions useful in the invention can possess at least one of the T g ranges described herein and at least one of the monomer ranges for the compositions described herein unless otherwise stated. It is also contemplated that compositions useful in the invention can possess at least one of the inherent viscosity ranges described herein, at least one of the T g ranges described herein, and at least one of the monomer ranges for the compositions described herein unless otherwise stated.

The polyester portion of the polyester compositions useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general can be prepared by condensing the dicarboxylic acid or dicarboxylic acid ester with the glycol in the presence of the lithium catalyst(s) and gallium(s) (and optionally, other catalysts), as described herein, at elevated temperatures increased gradually during the course of the condensation up to a temperature of about 225°−310° C., in an inert atmosphere, and conducting the condensation at low pressure during the latter part of the condensation, as described in further detail in U.S. Pat. No. 2,720,507 incorporated herein by reference.

In another embodiment, this invention relates to a process for preparing copolyesters of the invention. In certain embodiments, this process comprises the steps of:
(A) heating a mixture comprising the monomers useful in the polyesters of the invention in the presence of at least one lithium catalyst and at least one gallium catalyst at a temperature of 150 to 300° C. for a time sufficient to produce an initial polyester;
(B) polycondensing the product of Step (A) by heating it at a temperature of 230 to 320° C. for 1 to 6 hours; and
(C) removing any unreacted glycols.

Reaction times for the esterification Step (A) are dependent upon the selected temperatures, pressures, and feed mole ratios of glycol to dicarboxylic acid.

In one embodiment, step (A) may or may not be carried out until 50% by weight or more of the TMCD has been reacted. Step (A) may or may not be carried out under pressure, ranging from 0 psig to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

In certain embodiments, Step (B) and Step (C) can be conducted at the same time. These steps can be carried out by methods known in the art such as by placing the reaction mixture under a pressure ranging, from 0.002 psig to below atmospheric pressure, or by blowing hot nitrogen gas over the mixture.

In one embodiment, the invention relates to a process for making a polyester comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 10 to about 50 mole % TMCD residues; and
      (ii) about 50 to about 90 mole % of residues of CHDM;
   wherein the molar ratio of glycol component/dicarboxylic acid component added in Step (I) is 1.01-3.0/1.0 and wherein TMCD is added in an amount from about 10 to 50 mole %, optionally, to avow for at least 30% conversion of TMCD in the reaction, and to arrive at a final polymer having about 10 to 50 mole % TMCD residues;
   wherein the mixture in Step (I) is heated in the presence of:
      (i) at least two catalysts comprising lithium and gallium; and (ii) and, optionally, at least one phosphorus compound;
(II) heating the product of Step (I) at a temperature of 230° C. to 320° C. for 1 to 6 hours, under at least one pressure chosen from the range of the final pressure of Step (I) to 0.02 torr absolute, to form a final polyester;
wherein the total mole % of the dicarboxylic acid component of the final polyester is 100 mole %; and wherein the total mole % of the glycol component of the final polyester is 100 mole %;
wherein the inherent viscosity of the polyester is from 0.35 to 0.80 dL/g as determined in 60/40 (wt/wt) phenol/tetrachloroethane at a concentration of 0.25 g/50 ml at 25° C.; and wherein the L* color values for the polyester(s) and/or polyester composition(s) can be from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 99, or from 70 to 95, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In certain embodiments, the catalyst comprises no tin, and/or no titanium. In one embodiment, the polyesters of the invention can comprise at least one phosphate compound, whether or not present as a thermal stabilizer.

In the processes of the invention, at least one phosphorus compound, for example, at least one phosphate ester, can be added to Step (I), Step (II) and/or Steps (I) and (H) and/or after Steps (I) and/or (H). In certain embodiments, at least one phosphorus compound can be added to only Step (I) or only Step (II).

In certain embodiments of the invention, at least one phosphorus compound, reaction products thereof, and combinations thereof can be added either during esterification, polycondensation, or both and/or it can be added post-polymerization. In one embodiment, the phosphorus compound useful in any of the processes of the invention can be added during esterification. In one embodiment, if the phosphorus compound added after both esterification and polycondensation, it is added in the amount of 0 to 2 weight % based on the total weight of the final polyester. In one embodiment, if the phosphorus compound added after both esterification and polycondensation, it is added in the amount of 0.01 to 2 weight %, based on the total weight of the final polyester. In one embodiment, the phosphorus compound can comprise at least one phosphate ester. In one embodiment, the phosphorus compound can comprise at least one phosphorus compound which is added during the esterification step. In one embodiment, the phosphorus compound can comprise at least one phosphate ester, for example, which is added during the esterification step.

Reaction times for the esterification Step (I) of any of the processes of the invention are dependent upon the selected temperatures, pressures, and feed mole ratios of glycol to dicarboxylic acid.

In one embodiment, the pressure used in Step (II) of any of the processes of the invention can consist of at least one pressure chosen from 20 torr absolute to 0.02 torr absolute; in one embodiment, the pressure used in Step (II) of any of the processes of the invention can consist of at least one pressure chosen from 10 torr absolute to 0.02 torr absolute; in one embodiment, the pressure used in Step (II) of any of the processes of the invention can consist of at least one pressure chosen from 5 torr absolute to 0.02 torr absolute; in one embodiment, the pressure used in Step (II) of any of the processes of the invention can consist of at least one pressure chosen from 3 torr absolute to 0.02 torr absolute; in one embodiment, the pressure used in Step (II) of any of the processes of the invention can consist of at least one pressure chosen from 20 torr absolute to 0.1 torr absolute; in one embodiment, the pressure used in Step (II) of any of the processes of the invention can consist of at least one pressure chosen from 10 torr absolute to 0.1 torr absolute; in one embodiment, the pressure used in Step (II) of any of the processes of the invention can consist of at least one pressure chosen from 5 torr absolute to 0.1 torr absolute; in one embodiment, the pressure used in Step (II) of any of the processes of the invention can consist of at least one pressure chosen from 3 torr absolute to 0.1 torr absolute.

In one embodiment, the molar ratio of glycol component/dicarboxylic acid component added in Step (I) of a process of the invention is 1.0-2.0/1.0; in one embodiment, the molar ratio of glycol component/dicarboxylic acid component added in Step (I) of a process of the invention is 1.01-2.0/1.0; in one embodiment, the molar ratio of glycol component/dicarboxylic acid component added in Step (I) of a process of the invention is 1.01-1.75/1.0; in one embodiment, the molar ratio of glycol component/dicarboxylic acid component added in Step (I) of a process of the invention is 1.01-1.7/1.0; in one embodiment, the molar ratio of glycol component/dicarboxylic acid component added in Step (I) of a process of the invention is 1.01-1.5/1.0; in one embodiment, the molar ratio of glycol component/dicarboxylic acid component added in Step (I) of a process of the invention is 1.01-1.2/1.0.

In embodiments of the invention for the process for making the polyesters, the heating time of Step (II) can be from 1 to 5 hours or 1 to 4 hours or 1 to 3 hours or 1.5 to 3 hours or 1 to 2 hours. In one embodiment, the heating time of Step (II) can be from 1.5 to 3 hours.

In one embodiment, the polyesters, polyester compositions and/or processes of the invention useful in the invention can comprise lithium atoms, gallium atoms, and optionally, phosphorus atoms.

In embodiments of the invention, certain agents which colorize the polymer can be added to the melt. In one embodiment, a bluing toner is added to the melt in order to reduce the b* of the resulting polyester polymer melt phase product. Such bluing agents include blue inorganic and organic toner(s). In addition, red toner(s) can also be used to adjust the a* color value. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition can be a neat blend of the red and blue compounds or the composition can be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm are used. In one embodiment, the total amount of bluing additive can range from 0.5 to 10 ppm. In an embodiment, the toner(s) can be added to the esterification zone or to the polycondensation zone. Preferably, the toner(s) are added to the esterification zone or to the early stages of the polycondensation zone, such as to a prepolymerization reactor.

The invention further relates to a polymer blend. The blend comprises:
(a) from 5 to 95 weight % of at least one of the polyesters described above; and
(b) from 5 to 95 weight % of at least one of the polymeric components.

Suitable examples of the polymeric components include, but are not limited to, nylon; polyesters different than those described herein such as PET; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or polyphenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or combinations of any of the foregoing polymers. The blends can be prepared by conventional processing techniques known in the art, such as melt blending or solution blending.

In one embodiment, the final polyesters and/or polyester compositions of the invention can be blended with recycled poly(ethylene terephthalate)(rPET).

In embodiments, the polyester compositions and the polymer blend compositions can also contain from 0.01 to 25% by weight of the overall composition common additives such as colorants, toner(s), dyes, mold release agents, flame retardants, plasticizers, nucleating agents, stabilizers, including but not limited to, UV stabilizers, thermal stabilizers other than the phosphorus compounds describe herein, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials can be added to the compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, combinations of glass and talc, glass and mica, and glass and polymeric fibers.

In one embodiment, certain polyesters of this invention can be visually clear. The term “visually clear” is defined herein as an appreciable absence of cloudiness, haziness, and/or muddiness, when inspected visually.

In one embodiment, the polyesters and/or polyester compositions of the invention and/or the polyester of the invention, [in one embodiment, in the presence of and/or in the absence of toner(s)], can have color values L*, a* and b* which can be determined using a Hunter Lab Ultrascan Spectra Colorimeter manufactured by Hunter Associates Lab Inc., Reston, Va. The color determinations are averages of values measured on either pellets of the polyesters or plaques or other items injection molded or extruded from them. They are determined by the L*a*b* color system of the CIE (International Commission on Illumination) (translated), wherein L* represents the lightness coordinate, a* value represents the red/green coordinate, and b* represents the yellow/blue coordinate.

In certain embodiments, the b* values for the polyesters and/or polyester compositions of the invention can be from −10 to less than 15; −10 to less than 10, or from −3 to 10, or from −5 to 5, or from −5 to 4, or from −5 to 3, or from 1 to 20, or from 1 to 18, or from 1 to 15, or from 1 to 14, or from 1 to 12, or 1 to less than 10, or from 1 to 10, or from 1 to 9, or from 1 to 8, or from 1 to 7, or from 1 to 6, or from 1 to 5, or from 2 to 15, or from 2 to 14, or from 2 to less than 10, or from 3 to 15, or from 3 to 14, or 3 to less than 10, or from 3 to less than 9, or less than 20, or less than 15, or less than 14, or less than 13, or less than 12, or less than 11, or less than 10, or less than 9, or less than 8.5, or less than 8, or less than 7, or less than 6, or less than 6.5, or less than 5, or less than 4, or less than 3, as determined by the L*a*b* color system of the CIE (International Commission on Illumination).

In certain embodiments, the L* values for the polyesters and/or polyester compositions of the invention can be from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 99, or from 70 to 95, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In one embodiment, these values can be obtained in the presence of and/or in the absence of toner(s).

In any of the polyesters, polyester compositions and/or processes of the invention, the b* color for any given polyester of the invention can either remain stable at a certain inherent viscosity or decreases less than 20%, or less than 15%, or less than 10%, or less than 5%, when additional gallium is added or is present, as determined by the L*a*b* color system of the CIE (International Commission on Illumination).

Notched Izod impact strength, as described in ASTM 256 is a common method of measuring toughness. In one embodiment, the polyesters and/or polyester compositions of the invention can have a notched Izod impact strength of at least 1 ft-lbs/inch, or at least 2 ft-lbs/inch, or at least 3 ft-lbs/inch, or 7.5 ft-lbs/in, or 10 ft-lbs/in at 23° C. according to ASTM D256 with a 10-mil notch in a ⅛-inch thick bar.

Notched Izod impact strength is measured herein at 23° C. with a 10-mil notch in a 3.2 mm (⅛-inch) thick bar determined according to ASTM D256. In one embodiment, certain polyesters and/or polyester compositions of the invention can exhibit a notched Izod impact strength of at least 25 J/m (0.47 ft-lb/in) at 23° C. with a 10-mil notch in a 3.2 mm (⅛-inch) thick bar determined according to ASTM D256. In one embodiment, certain polyesters and/or polyester compositions of the invention can exhibit a notched Izod impact strength of from about 25 J/m (0.47 ft-lb/in) to about 75 J/m (1.41 ft-lb/in) at 23° C. with a 10-mil notch in a 3.2 mm (⅛-inch) thick bar determined according to ASTM D256. In another embodiment, certain polyesters and/or polyester compositions of the invention can exhibit a notched Izod impact strength of from about 50 J/m (0.94 ft-lb/in) to about 75 J/m (1.41 ft-lb/in) at 23° C. with a 10-mil notch in a 3.2 mm (⅛-inch) thick bar determined according to ASTM D256.

In one embodiment, certain polyesters and/or polyester compositions of the invention can exhibit at least one of the following densities: a density of greater than 1.2 g/ml at 23° C.

In one embodiment, the polyesters and/or polyester compositions of the invention can have a number average molecular weight of from 4,800 to 16,000.

In one embodiment, certain polyesters and/or polyester compositions of the invention useful in the invention can exhibit useful thermal stability of not more than 0.20 dL/g loss in inherent viscosity, or not more than 0.15 dL/g loss in inherent viscosity, or not more than 0.12 dL/g loss in inherent viscosity, or not more than 0.10 dL/g loss in inherent viscosity when heated at 300° C. for 1 to 5 hours, or from 1 to 4 hours, or from 2 to 3 hours, or for 2.5 hours, where inherent viscosity is determined in 60/40 (wt/wt) phenol/tetrachloroethane at a concentration of 0.5 g/100 ml at 25° C.

In one embodiment, certain polyesters and/or polyester compositions of the invention can exhibit a flexural modulus at 23° C. equal to or greater than 2000 MPa (290,000 psi) as defined by ASTM D790. In another embodiment, certain polyesters useful in the invention can exhibit a tensile strength at 23° C. from about 2000 MPa (290,000 psi) to about 2551 MPa (370,000 psi) as defined by ASTM D638. In another embodiment, certain polyesters useful in the invention can exhibit a flexural modulus at 23° C. from about 2000 MPa (290,000 psi) to about 2413 MPA (350,000 psi) as defined by ASTM D790.

In one embodiment, certain polyesters and/or polyester compositions of the invention can exhibit a flexural modulus at 23° C. equal to or greater than 2000 MPa (290,000 psi) as defined by ASTM D790. In another embodiment, certain polyesters and/or polyester compositions of the invention can exhibit a tensile strength at 23° C. from about 2000 MPa (290,000 psi) to about 2551 MPa (370,000 psi) as defined by ASTM D638. In another embodiment, certain polyesters and/or polyester compositions of the invention can exhibit a flexural modulus at 23° C. from about 2000 MPa (290,000 psi) to about 2413 MPA (350,000 psi) as defined by ASTM D790.

Certain polyesters and/or polyester compositions of the invention can possess at least one of the following properties: a Tg of from about 85 to about 130° C. as measured by a TA 2100 Thermal Analyst Instrument at a scan rate of 20° C./min; a flexural modulus at 23° C. equal to or greater than 2000 MPa (290,000 psi) as defined by ASTM D790; and a notched Izod impact strength equal to or greater than 25 J/m (0.47 ft-lb/in) according to ASTM D256 with a 10-mil notch using a ⅛-inch thick bar at 23° C.

In certain embodiments, the final polyesters and/or polyester compositions of the invention can comprise methyl groups in the amount of 5.0 mole % or less, or 4.5 mole % or less, or 4 mole % or less, or 3 mole % or less, or 2.5 mole % of less, or 2.0 mole % or less, or 1.5 mole % or less, or 1.0 mole % or less, or 0.50 mole % or less.

In one embodiment, the processes of making the polyesters and/or polyester compositions of the invention can comprise a batch or continuous process.

In one embodiment, the processes of making the polyesters and/or polyester compositions of the invention comprise a continuous process.

In one embodiment, the polyesters and/or compositions are useful in making shaped articles, including, but not limited to, extruded, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, drinkware, medical parts, sheet and/or fibers.

In one embodiment, the invention is related to thermoformed film(s) and/or sheet(s) comprising the polyester(s) and/or polyester compositions of the invention.

In one embodiment, the invention is related to articles of manufacture which incorporate the thermoformed film and/or sheet of the invention.

In one embodiment, the invention relates to the film(s) and/or sheet(s) comprising the polyesters and/or polyester compositions and/or polymer blends of the invention. The methods of forming the polyesters and/or polyester compositions and/or blends into film(s) and/or sheet(s) are well known in the art. Examples of film(s) and/or sheet(s) of the invention including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

Examples of potential articles made from film and/or sheet useful in the invention include, but are not limited, to thermoformed sheet, graphic arts film, outdoor signs, ballistic glass, skylights, coating(s), coated articles, painted articles, shoe stiffeners, laminates, laminated articles, medical packaging, general packaging, and/or multiwall films or sheets.

In one embodiment, the invention relates to injection molded articles comprising the polyesters and/or polyester compositions and/or polymer blends of the invention. Injection molded articles can include injection stretch blow molded bottles, sun glass frames, lenses, sports bottles, drinkware, food containers, medical devices and connectors, medical housings, electronics housings, cable components, sound dampening articles, cosmetic containers, wearable electronics, toys, promotional goods, appliance parts, automotive interior parts, and consumer houseware articles.

Because of the long crystallization half-times (e.g., greater than 5 minutes) at 170° C. exhibited by certain polyesters of the present invention, it can be possible to produce articles, including but not limited to, injection molded parts, injection blow molded articles, injection stretch blow molded articles, extruded film, extruded sheet, extrusion blow molded articles, extrusion stretch blow molded articles, and fibers. A thermoformable sheet is an example of an article of manufacture provided by this invention. The polyesters of the invention can be amorphous or semicrystalline. In one embodiment, certain polyesters of the invention can have relatively low crystallinity. Certain polyesters of the invention can thus have a substantially amorphous morphology, meaning that the polyesters comprise substantially unordered regions of polymer.

In one embodiment, this invention includes processes for making any of the polyesters and/or polyester compositions of the invention.

In one embodiment, this invention includes a product made with any of the polyesters and/or polyester compositions of the invention and/or by any of the processes of the invention.

In one embodiment, this invention includes an article of manufacture made with any of the polyesters and/or polyester compositions of the invention.

In one embodiment, this invention includes an article of manufacture e.g., a shaped article, made with any of the polyesters and/or polyester compositions of the invention.

In one embodiment, the polyesters and/or polyester compositions of the invention can be useful for non-coating compositions, non-adhesive compositions, thermoplastic polyester compositions, articles of manufacture, shaped articles, thermoplastic shaped articles, molded articles, extruded articles, injection molded articles, blow molded articles, film and/or sheet (for example, calendered, cast, or extruded), thermoformed film or sheet, container, or bottle (for example, baby bottles or sports bottles or water bottles).

In one embodiment, the present invention comprises a thermoplastic article, typically in the form of sheet material, having a decorative material embedded therein which comprise any of the compositions described herein.

In one embodiment, the polyesters according to the invention can be used for appliance parts. “Appliance parts,” as used herein, refers to a rigid piece used in conjunction with an appliance. In one embodiment, the appliance part is partly or wholly separable from the appliance. In another embodiment, the appliance part is one that is typically made from a polymer. In one embodiment, the appliance part is visually clear.

In one embodiment, the polyesters according to the invention can be used for bottles and containers including those that are injection molded, injection blow molded, injection stretch blow molded, blow molded, or reheat blow molded. Articles made by these methods include dual wall tumblers, water bottles, sports bottles, bulk water containers, and baby bottles.

The following examples further illustrate how the polyesters and/or polyester compositions of the invention can be made and evaluated, and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

The following examples illustrate, in general, how copolyesters of this invention are prepared and the effect of using TMCD and CHDM, and certain catalyst and stabilizers, on various copolyester properties such as color and inherent viscosity (IV).

### Measurement Methods

The inherent viscosity of the polyesters was determined in 60/40 (wt/wt) phenol/tetrachloroethane at a concentration of 0.5 g/100 ml at 25° C., and is reported in dL/g.

The glycol content and the cis/trans ratio of the compositions were determined by proton nuclear magnetic resonance (NMR) spectroscopy. All NMR spectra were recorded on a JEOL Eclipse Plus 600 MHz nuclear magnetic resonance spectrometer using either chloroform-trifluoroacetic acid (70-30 volume/volume) for polymers or, for oligomeric samples, 60/40 (wt/wt) phenol/tetrachloroethane with deuterated chloroform added for lock. Peak assignments for 2,2,4,4-tetramethyl-1,3-cyclobutanediol resonances were made by comparison to model mono- and dibenzoate esters of 2,2,4,4-tetramethyl-1,3-cyclobutanediol. These model compounds closely approximate the resonance positions found in the polymers and oligomers.

Color values reported herein are CIELAB L*, a*, and b* values measured following ASTM D 6290-98 and ASTM E308-99, using measurements from a Hunter Lab Ultrascan XE Spectrophotometer (Hunter Associates Laboratory Inc., Reston, Va.) with the following parameters: (1) D65 illuminant, (2) 10 degree observer, (3) reflectance mode with specular angle included, (4) large area view, (5) 1″ port size. Unless stated otherwise, the measurements were performed on polymer granules ground to pass a 1 mm sieve.

The amount of gallium (Al), and lithium (Li) in the examples below is reported in parts per million (ppm) of metal and was measured by inductively coupled plasma mass spectrometry (ICP). The amount of phosphorous is similarly reported as ppm of elemental phosphorus and was also measured by ICP using the same instrument. The values reported in the column “P measured” in the following examples were obtained by measuring phosphorous as described above.

Unless otherwise specified, the cis/trans ratio of the 2,2,4,4-tetramethyl-1,3-cyclobutanediol used in the following examples was approximately 60/40 and could range from 45/55 to 99/1.

Unless otherwise noted, IV or I.V. is meant to refer to inherent viscosity measured as described herein.

### Examples 1-26—Preparation of the Copolyesters of Examples 1-26 in Tables 1-2

The process for the preparation of the copolyesters of Examples 1-26 in Tables 1-2 in the Examples is generally exemplified by the preparation of the copolyester of Example 20, as follows:

This example illustrates the preparation of a copolyester with a target composition of 100 mol % dimethyl terephthalate residues, 35 mole % TMCD residues, and 65 mole % CHDM residues. A mixture of 77.7 g of dimethyl terephthalate, 37.5 g of CHDM, 25.9 g of TMCD, 0.128 g of lithium acetylacetonate, and 0.217 g of gallium acetylacetonate was placed in a 500-milliliter flask equipped with an inlet for nitrogen, a metal stirrer, and a short distillation column. The flask was placed in a Wood's metal bath already heated to 220° C. The stirring speed was set to 175 RPM and this was held for 15 minutes. The contents of the flask were heated to 230° C. over 5 minutes while the stirring was simultaneous raised to 225° C. over that time. The contents were then raised to 245° C. slowly over 45 minutes. The content remained at 245° C. while the pressure was reduced to 250 torr over three minutes. The temperature was again raised to 265° C. over the course of 15 minutes. The pressure was then further reduced to 3.5 torr over the course of eight minutes. Finally, the temperature was increase to 277° C. while the stir rate slowly decreased to 50 RPM and the pressure dropped to 1 torr over the course of 20 minutes. The reaction was held at this final temperature, pressure and stir rate for 35 minutes. A high melt viscosity, visually clear polymer was obtained with an inherent viscosity of 0.661 dl/g. NMR analysis showed that the polymer was composed of 33.34 mole % TMCD residues.

TABLE 1
COPOLYESTERS COMPRISING TMCD, CHDM, AND 100
MOLE % DMT; Li and Ga (LiAcAc and GaAcAc)

| | | | | | Li | Ga | TMCD | CHDM | Catalyst | Li/Ga |
|---|---|---|---|---|---|---|---|---|---|---|
| Ex | a* | b* | L* | IV | (ppm) | (ppm) | Mol % | Mol % | ppm ttl | Ratio |
| 1 | −0.085 | 3.64 | 83.38 | 0.392 | 250 | 200 | 45 | 55 | 450 | 1 to 0.8 |
| 2 | −1 | 3.31 | 79.07 | 0.434 | 250 | 200 | 45 | 55 | 450 | 1 to 0.8 |
| 3 | −0.85 | 3.64 | 83.38 | 0.392 | 250 | 200 | 33.7 | 66.13 | 450 | 1 to 0.8 |
| 4 | −1 | 3.31 | 79.07 | 0.434 | 250 | 200 | 32.97 | 67.03 | 450 | 1 to 0.8 |
| 5 | −2.65 | 8.24 | 80.57 | 0.612 | 250 | 500 | 33.2 | 66.8 | 750 | 1 to 2 |
| 6 | −2.27 | 8.05 | 82.09 | 0.656 | 250 | 500 | 33.21 | 66.79 | 750 | 1 to 2 |
| 7 | −2.17 | 6.63 | 83.74 | 0.629 | 250 | 500 | 33.67 | 66.33 | 750 | 1 to 2 |
| 8 | −1.12 | 3.12 | 83.75 | 0.473 | 100 | 250 | 32.9 | 67.1 | 250 | 1 to 1.5 |
| 9 | −1.05 | 3.3 | 82.18 | 0.534 | 100 | 300 | 33.04 | 66.96 | 400 | 1 to 3 |
| 10 | −1.35 | 3.85 | 83.2 | 0.62 | 100 | 400 | 33.57 | 66.43 | 500 | 1 to 4 |
| 11 | −1.62 | 4.7 | 84.73 | 0.59 | 100 | 300 | 32.84 | 67.16 | 400 | 1 to 3 |
| 12 | N/A | N/A | N/A | N/A | 100 | 300 | N/A | N/A | 400 | 1 to 3 |
| 13 | −1.77 | 5.67 | 84.49 | 0.613 | 100 | 400 | 35.51 | 64.49 | 500 | 1 to 4 |
| 14 | −1.68 | 6.67 | 84.38 | 0.583 | 100 | 400 | 34.77 | 65.23 | 500 | 1 to 4 |
| 15 | −1.85 | 6.13 | 86.18 | 0.595 | 100 | 400 | 35.31 | 64.69 | 500 | 1 to 4 |
| 16 | −1.91 | 6.22 | 86.73 | 0.692 | 100 | 400 | 35.28 | 64.72 | 500 | 1 to 4 |
| 17 | −0.63 | 2.23 | 83.17 | 0.551 | 88 | 378 | 33.76 | 66.24 | 466 | 1 to 4.3 |
| 18 | −0.78 | 2.49 | 79.26 | 0.628 | 97 | 387 | 33.70 | 66.30 | 484 | 1.03 to 1 |
| 19 | −.62 | 2.20 | 82.15 | 0.632 | 89 | 412 | 33.12 | 66.88 | 501 | 1 to 3.99 |
| 20 | −0.60 | 2.40 | 79.50 | 0.661 | 97 | 409 | 33.34 | 66.66 | 506 | 1 to 4.22 |

*Examples 5, 6, and 7 were run with varying reaction times

Early experiments revealed that in tandem, lithium and gallium were capable of significant TMCD incorporation into a polyester resulting in high inherent viscosity. Significant color improvements were observed upon reducing the overall catalyst charge while TMCD incorporation and viscosity build were still very good. Together these results also demonstrated a good range of TMCD incorporation which could be manipulated via the mol-ratio of the glycol charges.

A comparative series of polymers were prepared with a tin and phosphorus catalyst package as shown in Table 2. Similar inherent viscosity, and TMCD conversion were observed when compared to lithium and gallium, however it should be noted that the phosphorus is believed to be needed when using a tin catalyst to bring color values down close to those observed with lithium and gallium.

TABLE 2
Copolyesters Comprising TMCD; CHDM; 100 mole
% DMT; Sn (ppm) and Phosphorus(P) (ppm); [Sn
source is butyltin tris(2-ethylhexanoate)]

| | | Cis- | | | | | | | |
|---|---|---|---|---|---|---|---|---|---|
| Example | TMCD | TMCD | CHDM | | | | IV- | | |
| Number | Mole % | Mole % | Mole % | a* | b* | L* | Inherent | Sn | P |
| 21 | 34.0 | 55/45 | 66.0 | N/A | 1.6 | 80.4 | 0.69 | 159 | 0 |
| 22 | 33.15 | 57.64/42.36 | 66.85 | −0.97 | 3.41 | 84.64 | 0.67 | 111.3 | 6.3 |
| 23 | 33.89 | 56.47/43.53 | 66.11 | −1.07 | 3.54 | 83.41 | 0.672 | 116.2 | 6.6 |
| 24 | 32.95 | 55.99/44.01 | 67.05 | −1.07 | 3.08 | 82.39 | 0.646 | 108 | 7.3 |
| 25 | 34.02 | 56.77 | 65.98 | −0.90 | 3.11 | 82.26 | 0.622 | 90.50 | 6.3 |
| 26 | 34.27 | 57.13 | 65.73 | −1.12 | 4.09 | 81.34 | 0.672 | 107.50 | 8.0 |

It is unpredictable that a Li/Ga catalyst system compares favorably with the use of a tin catalyst system in obtaining similar good inherent viscosities and similar good color (without the need for phosphorus) as shown in Table 2).

A comparative series of polymers were synthesized with a tin catalyst. Color, viscosity and TMCD incorporation were observed to be comparable to those provided by the Li/Ga system described in this work.

Polymers prepared with lithium and gallium in combination and in various loadings were observed to compare favorably to TMCD containing polymers prepared with tin.

This disclosure has been described in detail with particular reference to preferred embodiments thereof, but it will be understood that variations and modifications can be effected within the spirit and scope of the disclosure.

1. A polyester composition comprising:
(1) at least one polyester which comprises:
(a) a dicarboxylic acid component comprising:
(i) about 70 to about 100 mole % residues of terephthalic acid or esters thereof;
(ii) about 0 to about 30 mole % of aromatic and/or aliphatic dicarboxylic acid residues having up to 20 carbon atoms;
(b) a glycol component comprising:
(i) about 10 to about 50 mole % of 2,2,4,4-tetramethyl-1,3-cyclobutanediol residues;
(ii) about 50 to about 90 mole % residues of 1,4-cyclohexanedimethanol;
wherein the total mole % of the dicarboxylic acid component is 100 mole %,
wherein the total mole % of the diol component is 100 mole %; and
(2) lithium atoms, gallium atoms, and less than 30 ppm of tin atoms.

2. The polyester composition of claim 1 wherein at least one polyester comprises modifying glycols comprising at least one of diethylene glycol, 1,2-propanediol, 1,3-propanediol, 2-methyl-1,3-propanediol, ethylene glycol, 1,4-butanediol, 1,5-pentanediol, 1,6-hexanediol, p-xylene glycol, neopentyl glycol, isosorbide, polytetramethylene glycol, or combinations thereof.

3. The polyester composition of claim 1, wherein at least one polyester comprises residues of 2,2,4,4-tetramethyl-1,3-cyclobutanediol in the amount of from about 10 to about 40 mole %.

4. The polyester composition of claim 1, wherein at least one polyester comprises 1,4-cyclohexanedimethanol residues in the amount of from about 55 to about 90 mole %.

5. The polyester composition of claim 1, wherein at least one polyester comprises residues of diethylene glycol in the amount of from about 50 to about 90 mole %.

6. (canceled)

7. The polyester composition of claim 1, wherein the inherent viscosity is from 0.35 to 1.2 dL/g, as determined in 60/40 (wt/wt) phenol/tetrachloroethane at a concentration of 0.5 g/100 ml at 25° C.

8. The polyester composition of claim 1, comprising less than 30 ppm of titanium atoms.

9. The polyester composition of claim 1, comprising less than 30 ppm of manganese atoms.

10. The polyester composition of claim 1, comprising less than 30 ppm of zinc atoms.

11. The polyester composition of claim 1, comprising lithium atoms in the amount of from or from 20 to 500 ppm, relative to the mass of final polyester being prepared.

12. The polyester composition of claim 1, comprising gallium atoms in the amount of from 50 to 1000 ppm, relative to the mass of final polyester being prepared.

13. The polyester composition of claim 1, wherein the ratio of lithium atoms to gallium atoms in ppm relative to the mass of final polyester being prepared from 0.50-1:5 to 5:1.

14. The polyester composition of claim 1, wherein the total of catalyst metal atoms present in the composition is in the range of from 200 to 1000 ppm, relative to the mass of final polyester being prepared.

15. The polyester composition of claim 1, wherein at least one lithium source is selected from at least one of lithium carbonate, lithium acetate, lithium benzoate, lithium succinate, lithium acetylacetonate, lithium methoxide, lithium oxalate, lithium nitrate, lithium ethoxide, lithium hydroxide, lithium hydride, lithium glycoxide, alkyl lithium, lithium gallium hydride, lithium borohydride, lithium oxide; or wherein at least one lithium source is lithium acetylacetonate.

16. The polyester composition of claim 1, wherein at least one gallium source is selected from gallium acetate, gallium benzoate, gallium sulfate, gallium lactate, gallium laurate, gallium stearate, gallium alcoholates, gallium ethylate, gallium isopropoxide, gallium tri-n-butyrate, gallium tri-tert-butyrate, mono-sec-butoxygallium diisopropylate, and gallium chelates, ethyl acetoacetate gallium diisopropylate, gallium tris(ethyl acetoacetate), alkyl acetoacetate, gallium diisopropylate, gallium monoacetylacetate bis(ethyl acetoacetate), gallium tris(acetyl acetate), or gallium acetylacetonate; or
wherein at least one gallium source is selected from gallium hydroxide, gallium acetylacetonate, gallium acetate, gallium isopropoxide or gallium sulfate; or wherein at least one gallium source is selected from gallium acetylacetonate and gallium isopropoxide.

17. The polyester composition of claim 1, wherein said 2,2,4,4-tetramethyl-1,3-cyclobutanediol residues are a combination comprising greater than 70 mole % cis-2,2,4,4-tetramethyl-1,3-cyclobutanediol and less than 30 mole % trans-2,2,4,4-tetramethyl-1,3-cyclobutanediol; wherein the total mole percentages for cis- and trans-2,2,4,4-tetramethyl-1,3-cyclobutanediol is equal to 100 mole %.

18. The polyester composition of claim 1, wherein said polyester composition comprises at least one polymer chosen from at least one of the following: polyesters other than those in claim 1, poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones); or wherein said polyester composition comprises a blend of said polyester with recycled poly(ethylene terephthalate)(rPET).

19. The polyester composition of claim 1, comprising residues of at least one phosphorus compound.

20. The polyester composition of claim 1, wherein the extent of TMCD incorporation or conversion in the final polyester is greater than 55 mole %.

21. An article of manufacture made with the polyester composition of claim 1.
